(19) United States
(12) Patent Application Publication
(10) Pub. No.: US 2009/0257453 A1
(43) Pub. Date: Oct. 15, 2009

(54) TRANSMISSION APPARATUS AND RECEIVING APPARATUS

(76) Inventors: Ryogo Yanagisawa, Osaka (JP); Syuji Kato, Osaka (JP); Satoshi Takahashi, Osaka (JP)

Correspondence Address: MCDERMOTT WILL & EMERY LLP, 600 13TH STREET, NW, WASHINGTON, DC, 20005-3096, US

(21) Appl. No.: 12/420,506

(22) Filed: Apr. 8, 2009

(30) Foreign Application Priority Data
Apr. 11, 2008 (JP) 2008-103444

(51) Int. Cl. H04J 1/00

(52) U.S. Cl. 370/480

(57) ABSTRACT

In an audio and video transmission apparatus, a frequency division parameter control unit outputs a frequency division parameter Pt, Qt for relating a pixel clock (frequency: pclk) for video data with an audio clock (frequency: ft) for audio data. An audio/video/packet multiplexing unit converts audio data and the frequency division parameter Pt, Qt into packets, and superimposes the packets into blanking intervals of video data, thereby producing transmission data. The frequency division parameter Pt, Qt satisfies a relationship represented by:

pclk/Pt=ft/Qt=fpt, and

cause fpt to have a value that falls outside of a predetermined band that is determined as the band of audio data.

### CROSS REFERENCE TO RELATED APPLICATIONS

This application claims priority to Japanese Patent Application No. 2008-103444 filed Apr. 11, 2008, the disclosure of which, including specification, drawings and claims, is incorporated herein by reference in its entirety.

### BACKGROUND OF THE INVENTION

1. Field of the Invention

The present disclosure generally relates to a transmission apparatus and a receiving apparatus for high-speed transmission of video data and audio data.

2. Description of the Related Art

Conventionally, Digital Visual Interface (DVI) standards are known as interface standards for high-speed transmission of digital video data between, for example, a computer and a display. WO2002/078336 discloses a technique of transmitting video data multiplexed with audio data in accordance with DVI standards.

FIG. 27 is a block diagram showing an exemplary configuration of a conventional transmission/reception system. In FIG. 27, a transmission apparatus 501 and a receiving apparatus 601 are connected to each other via a transmission path compliant with DVI standards. The transmission apparatus 501 multiplexes video data with audio data and transmits the resultant multiplexed data to the receiving apparatus 601. Examples of the transmission apparatus 501 include a DVD player, a Blu-ray Disc (BD) recorder and the like. Examples of the receiving apparatus 601 include a plasma television, a liquid crystal television and the like.

Here, in the transmission path compliant with DVI standards, a pixel clock synchronous with video data can be transmitted, but an audio clock synchronous with audio data cannot be transmitted. Therefore, in WO2002/078336, a frequency division parameter determining unit 53 is provided in the transmission apparatus 501, which obtains a frequency division parameter M, N for relating a pixel clock with an audio clock, and transmits the frequency division parameter M, N instead of the audio clock.

FIG. 28 is a diagram for describing a relationship between an audio clock and a pixel clock and the frequency division parameter M, N. The frequency f of the audio clock is often set to be an integral multiple of a sampling frequency fs that is used when an audio signal that is originally an analog signal is digitized. In FIG. 28, the frequency f of the audio clock is assumed to be 128 times higher than the sampling frequency fs. Specifically, fs=48 kHz and f=128×fs=6.144 MHz.

The frequency division parameter N is a parameter for frequency-dividing the audio clock, and the frequency division parameter M is a parameter for frequency-dividing the pixel clock. The frequency f of the audio clock, the frequency pclk of the pixel clock, and the frequency division parameter M, N have a relationship represented by:

pclk/M=f/N=fpt,

wherein the value “fpt” also corresponds to a phase comparison frequency of a PLL for reproducing the audio clock.

For example, in order to obtain the frequency division parameter M, N, N may be set to have a predetermined value, and the 1/N frequency of the audio clock may be counted using the pixel clock and the result may be set as M. For example, when pclk=27 MHz and f=6.144 MHz, then if N is set to be 6144, fpt becomes 1 kHz, so that M=27,000 is obtained. FIG. 29 shows an exemplary configuration of the conventional frequency division parameter determining unit 53.

The frequency division parameter M, N thus obtained by the frequency division parameter determining unit 53 is converted into packets and is multiplexed into blanking intervals of video data by an audio/video/packet multiplexing unit 51. The audio/video/packet multiplexing unit 51 similarly converts audio data into packets and multiplexes the packets into blanking intervals of video data. For multiplexing, audio data is temporarily stored in a transmission data storing unit 52, and is output in synchronization with blanking intervals of video data. The transmission data storing unit 52 is typically an SRAM.

Video/audio/packet multiplexed data and a pixel clock output from the transmission apparatus 501 are transmitted via a transmission path, and are received by the receiving apparatus 601. In the receiving apparatus 601, an audio/video/packet separating unit 61 separates and outputs video data and a pixel clock. Video data is synchronous with a pixel clock, and is generally subjected to image processing for improvement of image quality in a subsequent stage before being displayed on a plasma panel or a liquid crystal panel.

The audio/video/packet separating unit 61 also separates and outputs the frequency division parameter M, N. An audio clock reproducing unit 63 reproduces an audio clock using the separated frequency division parameter M, N and the pixel clock. FIG. 30 shows an exemplary configuration of the conventional audio clock reproducing unit 63. As shown in FIG. 30, the audio clock reproducing unit 63 has a Phase Locked Loop (PLL) including a phase comparator 631, a Low Pass Filter (LPF) 632, a Voltage Controlled Oscillator (VCO) 633, and an N-frequency divider 634. By comparing the phase of the 1/M frequency of a pixel clock output from an M-frequency divider 635 with the phase of the 1/N frequency of an output of the VCO 633 output from the N-frequency divider 634, the oscillation frequency fr of the VCO 633 satisfies, by the effect of the PLL, a relationship represented by:

pclk/M=fr/N=fpr,

where fpr corresponds to a phase comparison frequency of the PLL. Since this relationship is the same as the relationship between the frequency division parameter M, N and the pixel clock and the audio clock in the transmission apparatus 501, the oscillation frequency fr of the VCO 633 is equal to the frequency f of the audio clock in the transmitter. In other words, the audio clock is reproduced in the receiver.

The audio data separated and output from the audio/video/packet separating unit 61 is temporarily accumulated in a received data storing unit 62, and is output in synchronization with an audio clock reproduced by the audio clock reproducing unit 63. In other words, audio data synchronous with the audio clock is output from the receiving apparatus 601. For example, if the audio data is converted into an analog signal using a DA converter 31, audio can be heard.

In recent years, the High-Definition Multimedia Interface (HDMI) has been widely employed as a technique of multiplexing and transmitting video data with audio data. HDMI is upwardly compatible with DVI and performs transmission in a manner similar to that described above, but selects N that satisfies a relationship represented by:

pclk/M=f/N=fpt=1 kHz.

This is because if the phase comparison frequency fpr of the audio clock reproducing unit is caused to be constant, the characteristics of the LPF can be maintained constant and the audio clock reproducing unit can be easily configured. Also, if a pixel clock and an audio clock are completely synchronous, M is invariably constant, so that the audio clock reproducing unit can satisfactorily reproduce the audio clock.

### SUMMARY OF THE INVENTION

With a conventional transmission/receiving apparatus as described above, video data multiplexed with audio data can be transmitted. However, since there have been recent and rapid advances in AV apparatuses, a technique of further improving sound quality is invariably required and desired.

In conventional transmission/receiving apparatuses, if a pixel clock and an audio clock are synchronous in a transmission apparatus, a receiving apparatus can satisfactorily reproduce the audio clock. However, if a pixel clock and an audio clock are not synchronous in a transmission apparatus, a receiving apparatus cannot necessarily satisfactorily reproduce the audio clock, and jitter is likely to be superimposed onto the reproduced audio clock. In this regard, the result of studies by the present inventors will be hereinafter described.

Specifically, if a pixel clock and an audio clock are not synchronous, then when the 1/N frequency of the audio clock is counted using the pixel clock, the resultant value is not necessarily constant. For example, even if a constant value N that satisfies:

f/N=1 kHz,

is selected, the result of counting the 1/N frequency of the audio clock using the pixel clock is not equal to the constant value M, i.e., the result of the counting varies like M1, M2, M3, and so on. If the varying frequency division parameter M1, M2, M3, . . . is employed, the following audio clock is reproduced in a receiver:

pclk/M1=f1/N

pclk/M2=f2/N

pclk/M3=f3/N.

Thus, as shown in FIG. 31, the reproduced audio clock achieves a smooth step response due to the effect of the LPF, but the frequency thereof finally varies, for example, f1, f2, f3, and so on.

The variation of the audio clock frequency leads to a deterioration in sound quality of an analog audio signal. Specifically, when audio data is converted into an analog audio signal by the DA converter 31, then if the audio clock frequency varies like f1, f2, f3, and so on, a distortion occurs in the analog audio signal due to the variation. The frequency of the distortion is about f/N, which is about 1 kHz in the case of the HDMI, for example. In other words, a distortion of about 1 kHz is superimposed on an analog audio signal, leading to a deterioration in sound quality, which is heard as noise.

In an effort to solve the problems described above, the present disclosure relates to a transmission and receiving apparatus as described herein. An object of the present disclosure is to provide a transmission apparatus and a receiving apparatus in a digital interface for audio/video transmission, in which a deterioration in sound quality of an audio signal is suppressed, so that high-sound quality audio data can be transmitted.

According to an aspect of the present disclosure, a transmission apparatus in a digital interface for audio/video transmission, includes a frequency division parameter control unit for outputting a frequency division parameter for relating a pixel clock for video data with an audio clock for audio data, and an audio/video/packet multiplexing unit for converting audio data to be transmitted and the frequency division parameter output from the frequency division parameter control unit into packets, and superimposing the packets into blanking intervals of video data to be transmitted, thereby producing transmission data. The transmission apparatus transmits the transmission data and the pixel clock. The frequency division parameter control unit outputs two integer values Pt and Qt as the frequency division parameter that satisfy a relationship represented by:

pclk/Pt=ft/Qt=fpt

where pclk represents a frequency of the pixel clock, and ft represents a frequency of the audio clock, and that cause fpt to fall out of a predetermined band including at least from 300 Hz to 3 kHz as a band of the audio data.

In this aspect of the present disclosure, the transmission apparatus can transmit, as a frequency division parameter for relating a pixel clock with an audio clock, a value that causes the frequency of distortion occurring in an audio signal due to the variation of the frequency of an audio clock reproduced in a receiving apparatus, to fall out of the band of audio data. Thereby, even if distortion occurs in an audio signal due to the variation of the frequency of a reproduced audio clock in a receiving apparatus, the distortion is not heard as noise, so that a deterioration in sound quality can be suppressed.

According to another aspect of the present disclosure, a transmission apparatus in a digital interface for audio/video transmission, includes a frequency division parameter determining unit for determining, as a frequency division parameter for relating a pixel clock for video data with an audio clock for audio data, two integer values Mt and Nt that satisfy a relationship represented by:

pclk/Mt=ft/Nt

where pclk represents a frequency of the pixel clock and ft represents a frequency of the audio clock, a frequency division parameter averaging unit for averaging either or both Mt and Nt, and outputting the result as an averaged frequency division parameter, and an audio/video/packet multiplexing unit for converting audio data to be transmitted and the averaged frequency division parameter into packets, and superimposing the packets into blanking intervals of video data to be transmitted, thereby producing transmission data. The transmission apparatus transmits the transmission data and the pixel clock.

In this aspect of the present disclosure, the transmission apparatus transmits an average of a frequency division parameter for relating a pixel clock with an audio clock. Thereby, in a receiving apparatus, a distortion in an audio signal due to the variation of the frequency of a reproduced audio clock is suppressed, so that a deterioration in sound quality can be suppressed.

The transmission apparatus of this aspect of the present disclosure may include an audio clock regenerating unit for generating a new audio clock based on the averaged frequency division parameter and the pixel clock. Audio data synchronous with the new audio clock may be used as the audio data to be transmitted.

Thereby, audio data generation in the transmission apparatus and audio data reproduction in the receiving apparatus have the same rate, thereby making it possible to prevent a decrease in audio quality.

According to another aspect of the present disclosure, a receiving apparatus in a digital interface for audio/video transmission, includes an audio/video/packet separating unit for separating, from received data, video data, audio data, and a frequency division parameter for relating a pixel clock for the video data with an audio clock for the audio data, an audio clock reproducing unit having a Phase Locked Loop (PLL), for reproducing an audio clock from a received pixel clock and the frequency division parameter by the PLL operating in a manner satisfying:

pclk/Pr=fr/Qr=fpr

where pclk represents a frequency of the pixel clock, fr represents a frequency of a reproduced audio clock, and Pr and Qr represent frequency division parameters, and a band determining unit for determining a band of fpr in the audio clock reproducing unit. The audio clock reproducing unit is configured to switch loop characteristics of the PLL, depending on the result of determination by the band determining unit.

According to this aspect of the present disclosure, the loop characteristics of the PLL in the audio clock reproducing unit are appropriately switched, depending on the band of fpr, thereby minimizing a time required to output an audio clock targeted by the PLL, i.e., a lock time, so that the occurrence of sound interruption can be prevented.

According to another aspect of the present disclosure, a receiving apparatus in a digital interface for audio/video transmission, includes an audio/video/packet separating unit for separating, from received data, video data, audio data, and a frequency division parameter for relating a pixel clock for the video data with an audio clock for the audio data, and an audio clock reproducing unit having a Phase Locked Loop (PLL), for reproducing an audio clock from a received pixel clock and the frequency division parameter by an operation of the PLL. The audio clock reproducing unit can support at least two types of frequency division parameters, and is configured to switch loop characteristics of the PLL, depending on the frequency division parameter type.

In this aspect of the present disclosure, the loop characteristics of the PLL in the audio clock reproducing unit are appropriately switched, depending on the frequency division parameter type, so that it is possible to avoid a situation in which sound is not produced or sound quality is deteriorated due to a mismatch between the frequency division parameter and the PLL characteristic.

According to another aspect of the present disclosure, a receiving apparatus in a digital interface for audio/video transmission, includes an audio/video/packet separating unit for separating, from received data, video data, audio data, and a frequency division parameter for relating a pixel clock for the video data with an audio clock for the audio data, a frequency division parameter regenerating unit for regenerating a new frequency division parameter from the frequency division parameter, and an audio clock reproducing unit having a Phase Locked Loop (PLL), for reproducing an audio clock from a received pixel clock and the new frequency division parameter by an operation of the PLL. The frequency division parameter regenerating unit regenerates, as the new frequency division parameter, two integer values Pr and Qr that satisfy a relationship represented by:

pclk/Pr=ft/Qr=fpr

where pclk represents a frequency of the pixel clock and ft represents a frequency of the audio clock, and that cause fpr to fall out of a predetermined band including at least from 300 Hz to 3 kHz as a band of the audio data.

In this aspect of the present disclosure, the receiving apparatus can regenerate, as a frequency division parameter for relating a pixel clock with an audio clock, a value that causes the frequency of a distortion occurring in an audio signal due to the variation of the frequency of a reproduced audio clock, to fall out of the band of audio data. Thereby, even if a distortion occurs in an audio signal due to the variation of the frequency of a reproduced audio clock in the receiving apparatus, the distortion is not heard as noise, so that a deterioration in sound quality can be suppressed.

According to another aspect of the present disclosure, a receiving apparatus in a digital interface for audio/video transmission, includes an audio/video/packet separating unit for separating, from received data, video data, audio data, and a frequency division parameter for relating a pixel clock for the video data with an audio clock for the audio data, a frequency division parameter averaging unit for averaging the frequency division parameter and outputs the averaged frequency division parameter, and an audio clock reproducing unit having a Phase Locked Loop (PLL), for reproducing an audio clock from a received pixel clock and the averaged frequency division parameter.

In this aspect of the present disclosure, the receiving apparatus employs an average of a frequency division parameter or relating a pixel clock with an audio clock. Thereby, in the receiving apparatus, a distortion in an audio signal due to the variation of the frequency of a reproduced audio clock is suppressed, so that a deterioration in sound quality can be suppressed.

As described above, according to the present disclosure, a deterioration in sound quality of an audio signal reproduced in a receiving apparatus is suppressed, so that high-sound quality audio data can be transmitted.

### BRIEF DESCRIPTION OF THE DRAWINGS

FIG. 1 is an exemplary block diagram showing an exemplary configuration of a transmission apparatus according to a first embodiment of the present disclosure.

FIG. 2 is an exemplary block diagram showing an exemplary configuration of a receiving apparatus according to the first embodiment.

FIG. 3 is an exemplary diagram showing an exemplary internal configuration of an audio clock reproducing unit in the configuration of FIG. 2.

FIG. 4 is an exemplary block diagram showing an exemplary configuration of a transmission/reception system according to the first embodiment.

FIG. 5 is an exemplary block diagram showing an exemplary configuration of a transmission apparatus according to a second embodiment of the present disclosure.

FIG. 6 is an exemplary diagram showing an exemplary internal configuration of a frequency division parameter control unit in the configuration of FIG. 5.

FIG. 7 is an exemplary block diagram showing an exemplary configuration of a receiving apparatus according to the second embodiment.

FIG. 8 is an exemplary block diagram showing an exemplary internal configuration of an audio clock reproducing unit in the configuration of FIG. 7.

FIG. 9 is an exemplary block diagram showing an exemplary configuration of a transmission/reception system according to the second embodiment.

FIG. 10 is an exemplary block diagram showing an exemplary configuration of a receiving apparatus according to a third embodiment of the present disclosure.

FIG. 11 is an exemplary diagram showing an exemplary internal configuration of a frequency division parameter regenerating unit in the configuration of FIG. 10.

FIG. 12 is an exemplary diagram showing the concept of regeneration of a frequency division parameter.

FIG. 13 is an exemplary diagram showing the concept of regeneration of a frequency division parameter.

FIG. 14 is an exemplary diagram showing an exemplary internal configuration of a frequency division parameter regenerating unit in the configuration of FIG. 10.

FIG. 15 is an exemplary diagram showing the concept of regeneration of a frequency division parameter.

FIG. 16 is an exemplary diagram showing the concept of regeneration of a frequency division parameter.

FIG. 17 is an exemplary block diagram showing an exemplary configuration of a transmission apparatus according to the third embodiment.

FIG. 18 is an exemplary block diagram showing an exemplary configuration of a transmission apparatus according to a fourth embodiment of the present disclosure.

FIG. 19 is an exemplary diagram showing an exemplary internal configuration of a frequency division parameter averaging unit in the configuration of FIG. 18.

FIG. 20 is an exemplary diagram showing the concept of the effect of averaging a frequency division parameter.

FIG. 21 is an exemplary block diagram showing an exemplary configuration of a variation of the transmission apparatus of the fourth embodiment of the present disclosure.

FIG. 22 is an exemplary block diagram showing a configuration of a receiving apparatus according to the fourth embodiment.

FIG. 23 is an exemplary diagram showing an exemplary internal configuration of an audio clock reproducing unit in the configuration of FIG. 22.

FIG. 24 is an exemplary diagram showing an exemplary internal configuration of an audio clock reproducing unit in the configuration of FIG. 22.

FIG. 25 is an exemplary diagram showing an exemplary internal configuration of an audio clock reproducing unit in the configuration of FIG. 22.

FIG. 26 is an exemplary diagram showing an exemplary internal configuration of a Δ−Σ converter in the configuration of FIG. 25.

FIG. 27 is a block diagram showing an exemplary configuration of a conventional transmission/reception system.

FIG. 28 is a diagram for describing a relationship between an audio clock and a pixel clock and the frequency division parameter.

FIG. 29 is a diagram showing an exemplary configuration of a conventional frequency division parameter determining unit.

FIG. 30 is a diagram showing an exemplary configuration of a conventional audio clock reproducing unit.

FIG. 31 is an exemplary diagram showing the concept of the variation of an audio clock frequency due to the variation of a frequency division parameter.

### DETAILED DESCRIPTION OF THE PREFERRED EMBODIMENTS

Hereinafter, embodiments of the present disclosure will be described with reference to the accompanying drawings. Note that, in the embodiments, a transmission apparatus and a receiving apparatus are connected to each other via a transmission path compliant with HDMI standards, which are upwardly compatible with DVI standards. The scope of the present disclosure is not limited to the HDMI as a digital interface for audio/video transmission, and is also applicable toother digital interfaces.

### First Embodiment

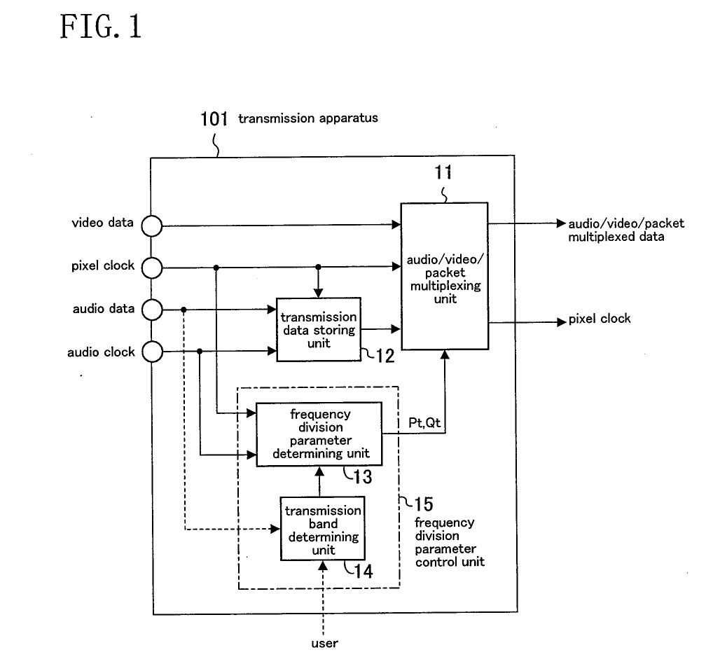

FIG. 1 is an exemplary block diagram showing an exemplary configuration of a transmission apparatus according to a first embodiment of the present disclosure. The transmission apparatus 101 of FIG. 1 comprises an audio/video/packet multiplexing unit 11, a transmission data storing unit 12, a frequency division parameter determining unit 13, and a transmission band determining unit 14.

In the configuration of FIG. 1, the frequency division parameter determining unit 13 determines a frequency division parameter Pt, Qt that is used to relate a pixel clock with an audio clock. Also, the frequency division parameter Pt, Qt is determined based on a band of audio data determined by the transmission band determining unit 14. The frequency division parameter determining unit 13 and the transmission band determining unit 14 constitute a frequency division parameter control unit 15 for outputting a frequency division parameter.

The transmission data storing unit 12, which includes, but not limited to, for example, an SRAM, temporarily stores audio data synchronous with an audio clock and outputs the audio data in synchronization with a pixel clock. The audio/video/packet multiplexing unit 11 converts the audio data output from the transmission data storing unit 12 into packets, and multiplexes the packets into blanking intervals of video data. The audio/video/packet multiplexing unit 11 also converts the frequency division parameter Pt, Qt output from the frequency division parameter determining unit 13 into packets, and multiplexes the packets into the video data blanking intervals. The resultant audio/video/packet multiplexed data is output as transmission data along with a pixel clock to the transmission apparatus 101.

It is noted that the frequency of an audio clock is represented by ft and the frequency of a pixel clock is represented by pclk. The frequency division parameter determining unit 13 determines the frequency division parameter Pt, Qt so that a frequency fpt represented by:

pclk/Pt=ft/Qt=fpt

falls outside (i.e., is not within the frequency band) of the audio data band determined by the transmission band determining unit 14.

Various audio data bands that are determined by the transmission band determining unit 14, and various determination techniques are contemplated. For example, if the band is assumed to have a fixed value, the band may be a human audio-frequency range (generally 20 Hz to 20 kHz) or a human voice-frequency range (generally 300 Hz to 4 kHz). Alternatively, the band may be a narrower range, e.g., 300 Hz to 1.5 kHz. Alternatively, the band may be a range of, e.g., 300 Hz to 3 kHz. In other words, a predetermined band including at least the range of 300 Hz to 3 kHz that tends to be recognized as noise by a human, is preferably defined as the audio data band. These values may be preset by a manufacturer.

Also, if the band is assumed to be variable, the band may be able to be set, for example, by the user who operates the transmission apparatus 101. Specifically, since the audio-frequency range varies from human to human, the user may be able to set a band with which the user recognizes a minimum level of noise while hearing audio reproduced by the receiving apparatus. Alternatively, the transmission band determining unit 14 may previously scan audio data to be transmitted, and determine the audio data band based on a maximum frequency and a minimum frequency included in the audio data.

In any case, the transmission band determining unit 14 determines both or either of the maximum frequency and the minimum frequency as the audio data band so as to maximize sound quality. This determination may be made one or more times for each individual piece of audio data, such as, but not limited to, a song, a broadcast program, a media program, etc. Alternatively, a value that is determined at a particular time may be utilized.

For example, if the audio data band is set to be the human audio-frequency range, the frequency division parameter determining unit 13 determines the frequency division parameter Pt, Qt so that fpt=20 Hz or 20 kHz, or fpt=10 Hz or 40 kHz, which falls outside of the audio-frequency range. Alternatively, fpt may be determined based on a sampling frequency fs of the audio data. For example, the value of fpt may be ½ of the sampling frequency fs, or more generally, V/U of the sampling frequency fs (U and V are integers).

Hereinafter, an example where fpt is set to be ½ of the audio data sampling frequency fs, will be described. If the sampling frequency fs is assumed to be 48 kHz, then:

fpt=fs/2=24 kHz.

If the audio clock frequency ft=128×fs, then:

128×fs/Qt=fs/2.

In this case, Qt=256. Therefore, the 1/256 frequency of an audio clock is counted using a pixel clock, so that Pt is determined that satisfies:

pclk/Pt=128×fs/Qt=fs/2.

The transmission apparatus 101 of this embodiment can be connected to a conventional receiving apparatus. In this case, the audio clock reproducing unit of the receiving apparatus reproduces an audio clock from the received frequency division parameter Pt, Qt using the PLL. If the frequency of the reproduced audio clock is represented by fr, then:

pclk/Pt=fr/Qt=fs/2.

Thus, the reproduced audio clock has the same frequency as that of the audio clock of the transmitter.

Here, if the pixel clock is not synchronous with the audio clock of the transmitter, distortion occurs in the audio clock reproduced in the receiver, and distortion also occurs in an analog audio signal output from the DA converter in accordance with the audio clock. Note that, since the phase comparison frequency of the PLL for reproduction of an audio clock is fs/2, the distortion of the reproduced audio clock has a frequency of fs/2, and therefore, the distortion of the analog audio signal also has a frequency of fs/2. Since the frequency of fs/2 is beyond the audio-frequency range, the auditory sense does not recognize the distortion. As a result, the transmission apparatus of this embodiment can transmit high-sound quality audio data.

Although it has been assumed above that fpt=fs/2, a similar effect can be obtained as long as fpt is set to fall outside of the audio data band as described above. Note that if fpt is particularly set to be an integral multiple of fs/2, the occurrence of unwanted aliasing noise can be prevented. For example, if 20 kHz, which is the upper limit of the human audio-frequency range, is selected as fpt, the difference (8 kHz) between an integral multiple thereof and the sampling frequency fs (=48 kHz) is superimposed onto the reproduced audio clock, leading to a deterioration in sound quality. In contrast to this, if fpt is set to be an integral multiple of fs/2, the occurrence of such aliasing noise can be prevented.

Note that if fpt is shifted to a higher frequency side of the audio data band, the feedback speed of the PLL is increased during reproduction of an audio clock in the receiving apparatus, so that the lock time is reduced, i.e., audio is output faster.

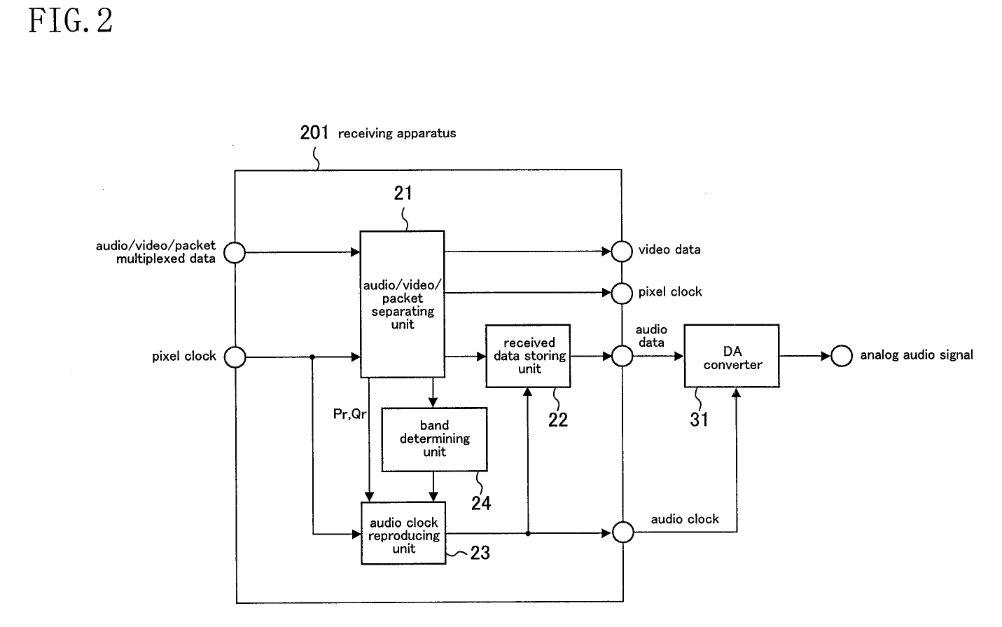

FIG. 2 is an exemplary block diagram showing an exemplary configuration of a receiving apparatus according to this embodiment. The receiving apparatus 201 of FIG. 2 is configured to support both the transmission apparatus 101 of this embodiment of FIG. 1 and conventional transmission apparatuses. The receiving apparatus 201 of FIG. 2 includes an audio/video/packet separating unit 21, a received data storing unit 22, an audio clock reproducing unit 23, and a band determining unit 24.

The audio/video/packet separating unit 21 separates video data, audio data, and a frequency division parameter Pr, Qr from received audio/video/packet multiplexed data. Video data, which is synchronous with a pixel clock, is generally subjected to image processing for improvement of image quality in a subsequent stage before being displayed on a plasma panel or a liquid crystal panel.

The separated frequency division parameter Pr, Qr is transferred to the audio clock reproducing unit 23. The audio clock reproducing unit 23, which includes a PLL, reproduces an audio clock from the pixel clock and the frequency division parameter Pr, Qr.

The separated audio data is temporarily accumulated in the received data storing unit 22, and is output from the received data storing unit 22 in synchronization with the audio clock reproduced by the audio clock reproducing unit 23. In other words, audio data synchronous with the audio clock is output from the receiving apparatus 201. For example, the output audio data is converted into an analog audio signal by the DA converter 31.

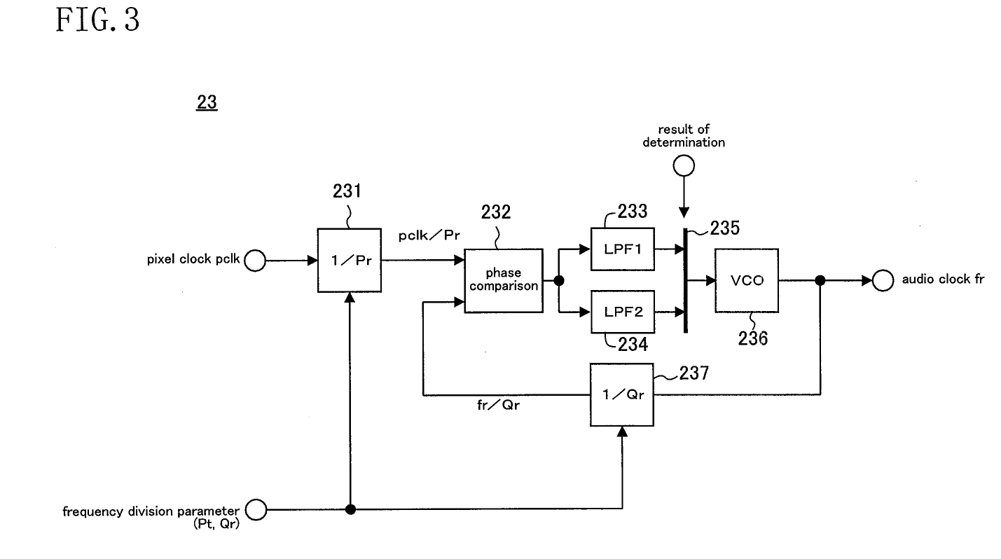

FIG. 3 is an exemplary diagram showing an exemplary internal configuration of the audio clock reproducing unit 23. The audio clock reproducing unit 23 of FIG. 3 comprises a frequency divider 231, a phase comparator 232, low-pass filters (LPF1 and LPF2) 233 and 234, a VCO 236 (oscillation frequency fr), and a frequency divider 237. The phase comparator 232 compares the 1/Pr frequency (frequency pclk/Pr) of a pixel clock output from the frequency divider 231 with the 1/Qr frequency (frequency fr/Qr) of a VCO output that is output from the frequency divider 237. By operation of the PLL, the oscillation frequency fr of the VCO 236 satisfies a relationship represented by:

pclk/Pr=fr/Qr=fpr

where fpr corresponds to the phase comparison frequency of the PLL. This relationship is the same as the relationship between the frequency division parameter Pt, Qt and a pixel clock and an audio clock in the transmission apparatus 101 of FIG. 1, for example. Therefore, the oscillation frequency fr of the VCO 236 is equal to the frequency ft of an audio clock in the transmitter. Thus, an audio clock is reproduced in the receiver.

Here, the value of the phase comparison frequency fpr varies depending on the characteristics of a transmission apparatus connected to the receiving apparatus 201. For example, when the transmission apparatus 101 of FIG. 1 is connected to the receiving apparatus 201, the phase comparison frequency fpr falls outside of an audio data band determined by the transmission band determining unit 14 as with fpt described above. In contrast to this, if a conventional transmission apparatus is connected to the receiving apparatus 201, the phase comparison frequency fpr normally falls within the audio data band.

Thus, the value of the phase comparison frequency fpr varies depending on the characteristics of a transmission apparatus connected to the receiving apparatus 201. Therefore, the receiving apparatus 201 of FIG. 2 is configured so that an expected band of the phase comparison frequency fpr is determined by the band determining unit 24, and depending on the result of determination, the loop characteristics of the PLL of the audio clock reproducing unit 23 are switched. Therefore, the audio clock reproducing unit 23 of FIG. 3 comprises a switch 235 for selecting the outputs of the low-pass filters 233 and 234.

Specifically, the switch 235 selects the output of the low-pass filter 233 having a narrow band when the phase comparison frequency fpr is low, and the output of the low-pass filter 234 having a broad band when the phase comparison frequency fpr is high. Thereby, the loop characteristics of the PLL are optimized, depending on the expected phase comparison frequency fpr. Therefore, the time (lock time) required to output an audio clock targeted by the PLL is minimized, so that the occurrence of sound interruption can be prevented.

Although it has been illustrated in FIG. 3 that two low-pass filters having a narrow band and a broad band are provided and switched, three or more low-pass filters may be provided and switched. In this case, the PLL can be optimized for various phase comparison frequencies fpr. Although it has also been illustrated that the loop characteristics of the PLL are switched by switching the characteristics of the low-pass filters, the voltage-frequency characteristics of the VCO may be switched, or alternatively, both the loop characteristics of the PLL and the voltage-frequency characteristics of the VCO may be switched. In any case, the loop characteristics of the PLL should be optimized, depending on the determined phase comparison frequency fpr.

Also, the PLL may include a digital circuit. In this case, the VCO includes, for example, a counter, and outputs triangular waves or sawtooth waves. As an operation clock for such a VCO, the pixel clock pclk may be employed. If a stable clock is supplied by a crystal oscillator, a stable audio clock independent of jitter in the pixel clock pclk can be reproduced. The same is true of receiving apparatuses described below.

The band determining unit 24 may determine the band of the phase comparison frequency fpr by, for example, comparing the frequency division parameter Pr, Qr with a predetermined value. For example, since fpr=fr/Qr, when the transmission apparatus causes the phase comparison frequency fpr to be higher than the audio data band, the frequency division parameter Qr has a smaller value. Therefore, when the frequency division parameter Qr is smaller than the predetermined value, the phase comparison frequency fpr should be determined to be high.

Alternatively, the transmission apparatus may add information that can be used to determine whether the phase comparison frequency fpr is high or low, to packets that transmit the frequency division parameter Pr, Qr. The information may be determined by the band determining unit 24. Specifically, for example, a frequency division parameter packet transmitted from a conventional transmission apparatus and a frequency division parameter packet transmitted from the transmission apparatus 101 of FIG. 1 may be set to have different header values.

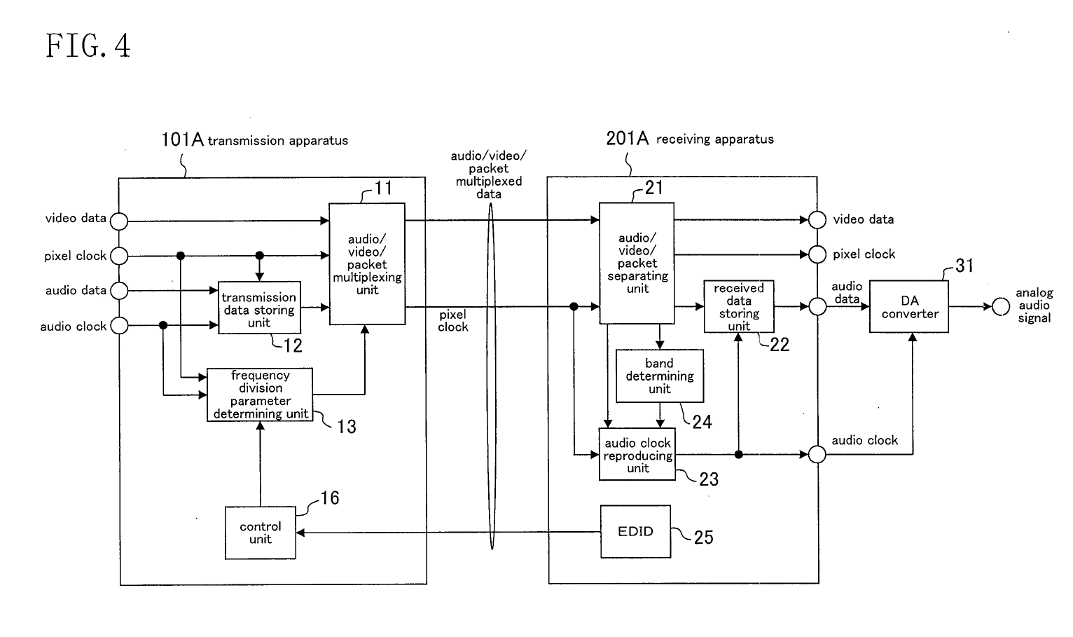

FIG. 4 is an exemplary block diagram showing an exemplary configuration of a transmission/reception system according to this embodiment. In FIG. 4, a transmission apparatus 101A and a receiving apparatus 201A have substantially the same basic configurations as those of the transmission apparatus 101 of FIG. 1 and the receiving apparatus 201 of FIG. 2 and the same components are indicated by the same reference symbols, except that the receiving apparatus 201A comprises a memory 25 for storing information about the receiving apparatus, and the transmission apparatus 101A comprises a control unit 16 for reading out the information of the memory 25, and sets a frequency division parameter to be transmitted, based on the read information about the receiving apparatus 201A.

An Enhanced Display Data Channel (EDID) is widely known as the memory 25 for storing the information about the receiving apparatus 201A. In general, the EDID includes a rewritable memory, such as an EEPROM or the like, and stores information about version, formats of video data and audio data that can be received by the receiving apparatus, and the like. For example, the control unit 16 of the transmission apparatus 101A reads out the version information of the EDID, and controls the frequency division parameter determining unit 13 so that the frequency division parameter determining unit 13 transmits a frequency division parameter that can be received by the receiving apparatus 201A. By performing such a control, the setting of the transmission band determining unit 14 that is required in the transmission apparatus 101 of FIG. 1 is not required, so that plug-and-play is allowed.

As described above, according to this embodiment, high-sound quality audio data can be transmitted and reproduced by a digital interface.

It has also been described in this embodiment that two values Pt and Qt (Pr and Qr) are transmitted (received). Alternatively, for example, the frequency division parameter Qt may have a fixed value and may be previously shared by a transmission apparatus and a receiving apparatus, and only the frequency division parameter Pt may be transmitted, thereby obtaining a similar effect.

### Second Embodiment

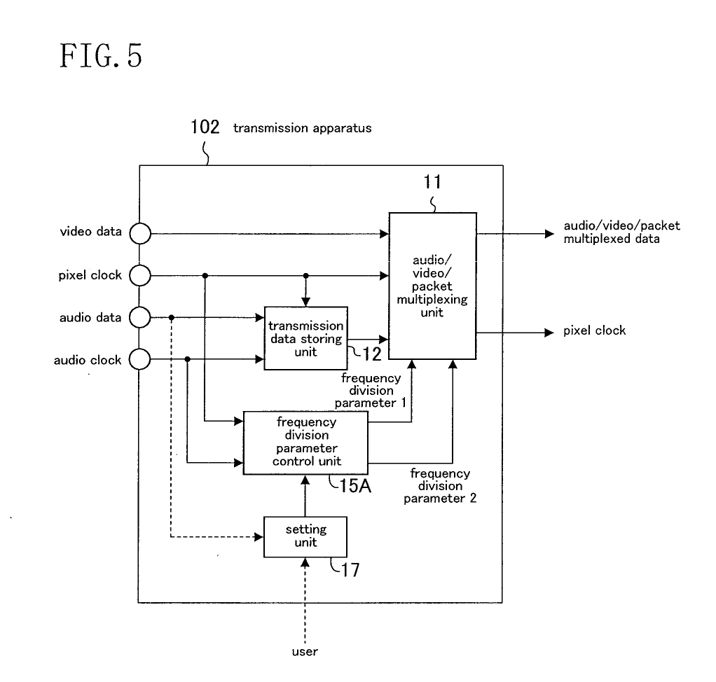

FIG. 5 is an exemplary block diagram showing an exemplary configuration of a transmission apparatus according to a second embodiment of the present disclosure. In FIG. 5, the same components as those of FIG. 1 are indicated by the same reference symbols and will not be described in detail again. The transmission apparatus 102 of FIG. 5 comprises an audio/video/packet multiplexing unit 11, a transmission data storing unit 12, a frequency division parameter control unit 15A, and a setting unit 17.

In the configuration of FIG. 5, the frequency division parameter control unit 15A outputs at least two types of frequency division parameters that are used to relate a pixel clock with an audio clock. For example, a frequency division parameter M, N that is compatible with conventional transmission apparatuses is output as a frequency division parameter 1, and a frequency division parameter Pt, Qt that is compatible with the transmission apparatus of the first embodiment is output as a frequency division parameter 2.

The setting unit 17 is used to set the type of a frequency division parameter that is to be output by the frequency division parameter control unit 15A. For example, the user of the transmission apparatus 102 can operate the setting unit 17 using a menu screen or the like. For example, the user controls the setting unit so that the frequency division parameter M, N is output when the receiver is a conventional receiving apparatus, and the frequency division parameter Pt, Qt is output when the receiver is the receiving apparatus of the first embodiment. Alternatively, the setting unit 17 may be used to perform setting, depending on audio data. For example, the frequency division parameter types are switched, depending on whether audio data is a music source or a movie source.

The audio/video/packet multiplexing unit 11 converts a frequency division parameter output from the frequency division parameter control unit 15A into packets, and multiplexes the packets into blanking intervals of video data and transmits the resultant packets. In this case, frequency division parameters of different types may be transmitted as the same packets. Alternatively, for example, if the frequency division parameter 1 and the frequency division parameter 2 are transmitted as packets having different headers, the processing required by the receiver is simplified.

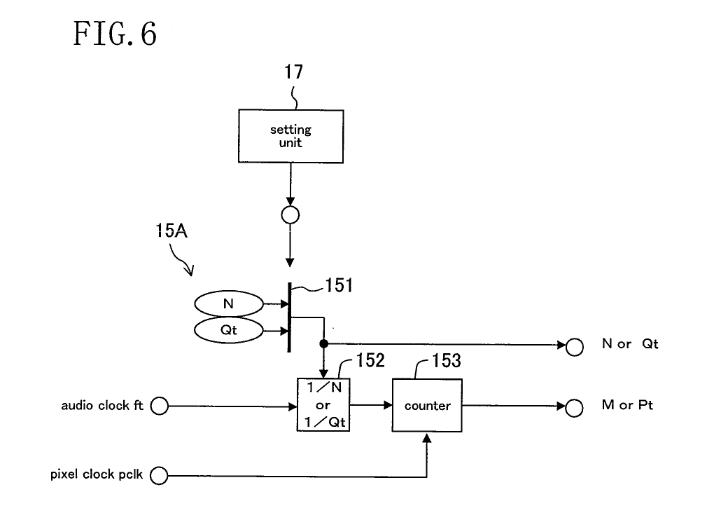

FIG. 6 is an exemplary diagram showing an exemplary internal configuration of the frequency division parameter control unit 15A of FIG. 5. In FIG. 6, a selector 151 selects either the frequency division parameter N or Qt, depending on the setting in the setting unit 17. A frequency divider 152 obtains the 1/N or 1/Qt frequency of an audio clock, and a counter 153 counts the period using a pixel clock. The count value of the counter 153 is output as the frequency division parameter M or Pt. Here,

pclk/M=ft/N

falls within the band of audio data, and

pclk/Pt=f/Qt

falls outside of the audio data band.

According to the transmission apparatus of this embodiment, the frequency division parameter types can be switched by the setting unit 17. Therefore, for example, while the frequency division parameter M, N may be transmitted to a conventional receiving apparatus, the frequency division parameter Pt, Qt may be transmitted to the receiving apparatus of the first embodiment. In this case, as compared to the conventional art, high-sound quality audio data can be transmitted. Also, it is possible to avoid transmission of the frequency division parameter Pt, Qt to a conventional receiving apparatus, so that it is possible to avoid a situation in which sound is not produced or sound quality is deteriorated due to a mismatch between a frequency division parameter and the PLL of a receiving apparatus.

Note that either one or a plurality of types of frequency division parameters may be provided for one piece of audio data. Note that when one type of frequency division parameter is provided for one piece of audio data, the circuit scale of a transmission apparatus can be reduced.

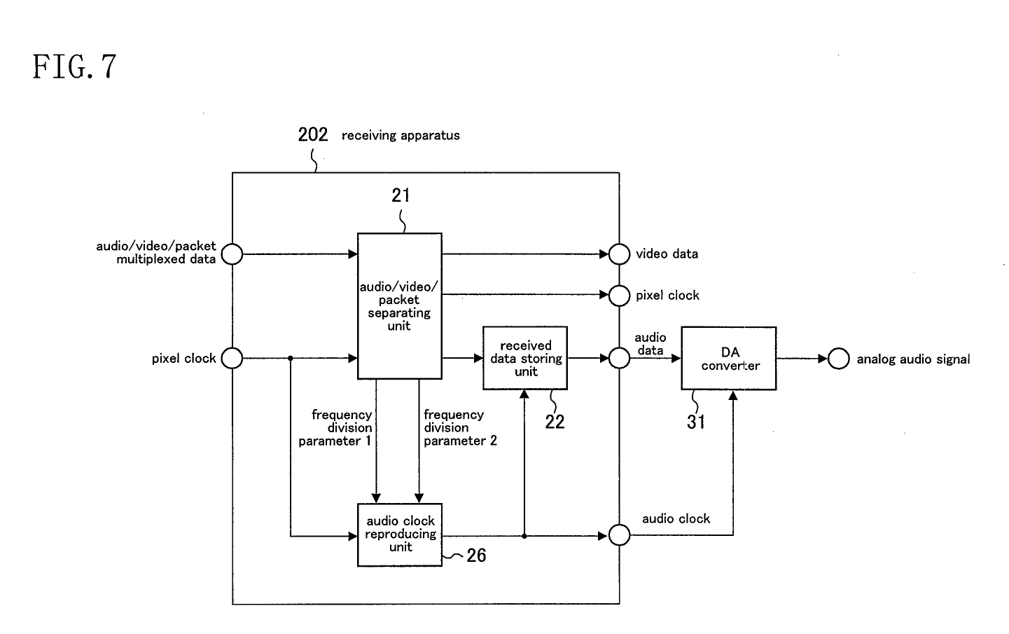

FIG. 7 is an exemplary block diagram showing an exemplary configuration of a receiving apparatus according to this embodiment. In FIG. 7, the same components as those of FIG. 2 are indicated by the same reference symbols and will not be described in detail again. The receiving apparatus 202 of FIG. 7 comprises an audio/video/packet separating unit 21, a received data storing unit 22, and an audio clock reproducing unit 26.

The audio clock reproducing unit 26 has a PLL, and reproduces an audio clock from a received pixel clock and a frequency division parameter separated from the audio/video/packet separating unit 21, by operation of the PLL. The audio clock reproducing unit 26 also supports at least two types of frequency division parameters, and is configured to switch the loop characteristics of the PLL, depending on the type of the frequency division parameter.

The audio/video/packet separating unit 21 separately outputs at least two types of frequency division parameters. For example, when the frequency division parameter M, N are included in transmission data, the parameter is output as the frequency division parameter 1, and when the frequency division parameter Pr, Qr is included in transmission data, the parameter is output as the frequency division parameter 2. For example, when the frequency division parameter M, N and the frequency division parameter Pr, Qr are transmitted in different packets, the frequency division parameter types are distinguished based on the header types of the packets. When the parameter is transmitted in the same packets, the frequency division parameter types may be distinguished and output based on whether N or Qr is larger than the other.

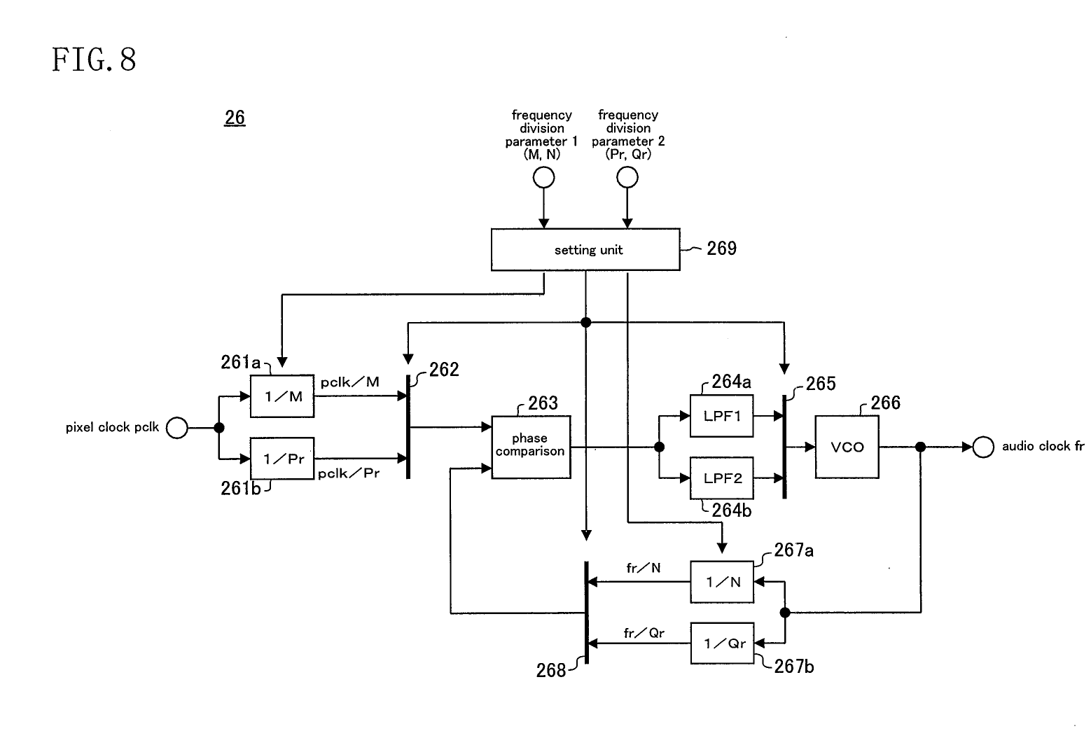

FIG. 8 is an exemplary block diagram showing an exemplary internal configuration of the audio clock reproducing unit 26 of FIG. 7. In the configuration of FIG. 8, a phase comparator 263 and a VCO 266 are shared by two types of frequency division parameters. A selector 262 selects one of outputs of frequency dividers 261a and 261b, a selector 265 selects one of outputs of low-pass filters 264a and 264b, and a selector 268 selects one of outputs of frequency dividers 267a and 267b. A setting unit 269 controls the selection operations of the selectors 262, 265 and 268, depending on whether a frequency division parameter separated by the audio/video/packet separating unit 21 is M, N or Pr, Qr. In other words, the setting unit 269 switches the loop characteristics of the PLL, depending on the frequency division parameter type.

With a configuration as shown in FIG. 8, optimum loop characteristics can be provided for each of the frequency division parameter M, N and the frequency division parameter Pr, Qr. Although an audio clock reproducing unit may be provided for each frequency division parameter type, the configuration can be simplified if a circuit is shared as shown in FIG. 8.

According to the receiving apparatus of this embodiment, for example, when the frequency division parameter M, N is received from a conventional transmission apparatus, audio having conventional sound quality can be reproduced, and when the frequency division parameter Pr, Qr is received from transmission apparatus of this embodiment or the first embodiment, audio data having higher sound quality than that of the conventional art can be reproduced. Also, even when the frequency division parameter Pr, Qr is received from a conventional transmission apparatus or the frequency division parameter M, N is received from the transmission apparatus of this embodiment, the operations of the audio clock reproducing unit 26 are appropriately switched. Therefore, it is possible to avoid a situation in which sound is not produced or sound quality is deteriorated due to a mismatch between a frequency division parameter and the characteristics of the PLL.

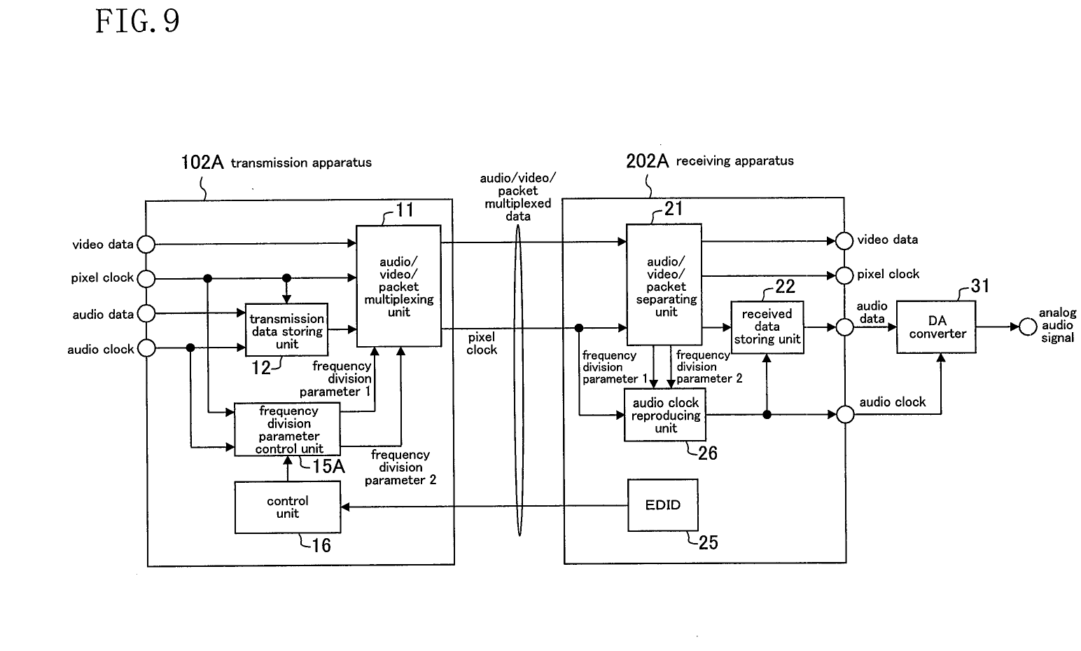

FIG. 9 is an exemplary block diagram showing an exemplary configuration of a transmission/reception system according to this embodiment. In FIG. 9, a transmission apparatus 102A and a receiving apparatus 202A have substantially the same basic configurations as those of the transmission apparatus 102 of FIG. 5 and the receiving apparatus 202 of FIG. 7, respectively, and the same components are indicated by the same reference symbols, except that the receiving apparatus 202A includes a memory 25 for storing information about the receiving apparatus, and the transmission apparatus 102A includes a control unit 16 for reading out the information of the memory 25 and sets a frequency division parameter to be transmitted, based on the read information about the receiving apparatus 201A.

As described above, the EDID (Enhanced Display Data Channel) is widely known as the memory 25 for storing the information about the receiving apparatus 202A. The control unit 16 of the transmission apparatus 102A reads out version information about the EDID, and controls the frequency division parameter control unit 15A so that the frequency division parameter control unit 15A transmits a frequency division parameter that can be received by the receiving apparatus 202A. By performing such a control, the setting by the setting unit 17 that is required in the transmission apparatus 102 of FIG. 5 is not required, so that plug-and-play is allowed.

As described above, according to this embodiment, high-sound quality audio data can be transmitted and reproduced by a digital interface.

It has also been described in this embodiment that two values Pt and Qt (Pr and Qr) are transmitted (received). Alternatively, for example, the frequency division parameter Qt may have a fixed value and may be previously shared by a transmission apparatus and a receiving apparatus, and only the frequency division parameter Pt may be transmitted, thereby obtaining a similar effect.

### Third Embodiment

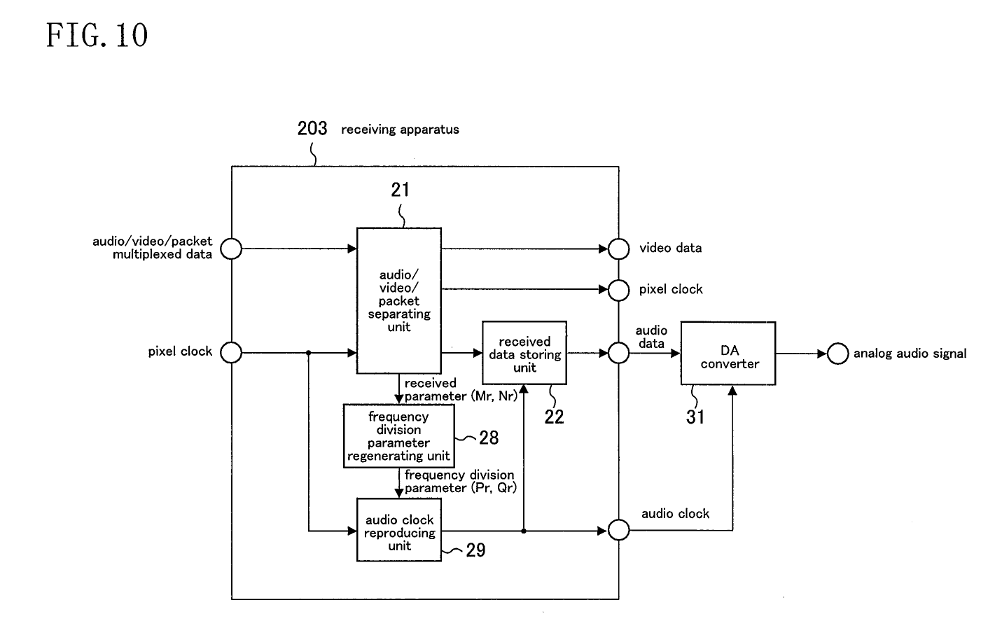

FIG. 10 is an exemplary block diagram showing an exemplary configuration of a receiving apparatus according to a third embodiment of the present disclosure. In FIG. 10, the same components as those of FIG. 2 are indicted by the same reference symbols and will not be described in detail again. The receiving apparatus 203 of FIG. 10 comprises an audio/video/packet separating unit 21, a received data storing unit 22, a frequency division parameter regenerating unit 28, and an audio clock reproducing unit 29.

The receiving apparatus 203 of this embodiment receives a frequency division parameter transmitted from a conventional transmission apparatus, and regenerates a frequency division parameter, such as that which is output from the transmission apparatus of the first embodiment, from the received frequency division parameter. Specifically, the frequency division parameter regenerating unit 28 regenerates the frequency division parameter Pr, Qr so that the newly regenerated frequency division parameter Pr, Qr satisfies:

pclk/Pr=ft/Qr=fpr

and fpr (corresponding to the phase comparison frequency of the PLL of the audio clock reproducing unit 29) falls outside of a predetermined audio data band.

Various audio data bands and various determination techniques are contemplated as in the first embodiment. For example, if the band is assumed to have a fixed value, the band may be a human audio-frequency range (generally 20 Hz to 20 kHz) or a human voice-frequency range (generally 300 Hz to 4 kHz). Alternatively, the band may be a narrower range, e.g., 300 Hz to 1.5 kHz. Alternatively, the band may be a range of, e.g., 300 Hz to 3 kHz. In other words, a predetermined band including at least the range of 300 Hz to 3 kHz that tends to be recognized as noise by a human, is preferably defined as the audio data band. These values may be preset by a manufacturer.

Also, if the band is assumed to be variable, the band may be able to be set by, for example, the user who operates the receiving apparatus 203. Specifically, since the audio-frequency range varies from human to human, the user may be able to set a band within which the user recognizes a minimum level of noise while hearing audio reproduced by the receiving apparatus. Alternatively, the frequency division parameter regenerating unit 28 may previously scan received audio data, and determine the audio data band based on a maximum frequency and a minimum frequency included in the audio data.

For example, if the audio data band is set to be the human audio-frequency range, the frequency division parameter regenerating unit 28 regenerates the frequency division parameter Pr, Qr so that fpr=20 Hz or 20 kHz, or fpr=10 Hz or 40 kHz, which falls outside of the audio-frequency range. Alternatively, fpr may be determined based on a sampling frequency fs of the audio data. For example, the value of fpr may be ½ of the sampling frequency fs, or more generally, V/U of the sampling frequency fs (U and V are integers).

An exemplary operation of the frequency division parameter regenerating unit 28 will be described in detail. It is here assumed that the receiving apparatus 203 receives a frequency division parameter Mr, Nr that is transmitted from a conventional transmission apparatus. Also, when the frequency of a pixel clock is represented by pclk, and the frequency ft of an audio clock is assumed to be:

ft=128×fs (fs: the sampling frequency of audio data),

the following relationship is obtained:

pclk/Mr=128×fs/Nr=ftr

where ftr normally falls within the audio data band.

The frequency division parameter regenerating unit 28 regenerates a new frequency division parameter Pr, Qr from the received frequency division parameter Mr, Nr.

Here,

pclk/Pr=128×fs/Qr=fpr

where fpr corresponds to the phase synchronization frequency of the PLL of the audio clock reproducing unit 29.

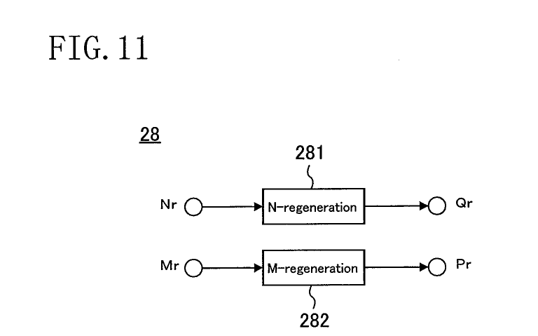

Firstly, a case where fpr is converted into a frequency that is higher than the upper limit of the audio data band, will be described. It is here assumed that fpr=fs/2. FIG. 11 is an exemplary diagram showing an exemplary internal configuration of the frequency division parameter regenerating unit 28 in this case.

In order to obtain fpr=fs/2, Qr should be equal to be 256. Therefore, an N-regenerating unit 281 replaces Nr with Qr=256. Next, since

(pclk/Mr)×(Nr/Qr)=(128×fs/Nr)×(Nr/Qr),

the following expression should be established:

Pr=(Mr×Qr)/Nr.

Therefore, since Qr=256, an M-regenerating unit 282 outputs:

Pr=256×Mr/Nr.

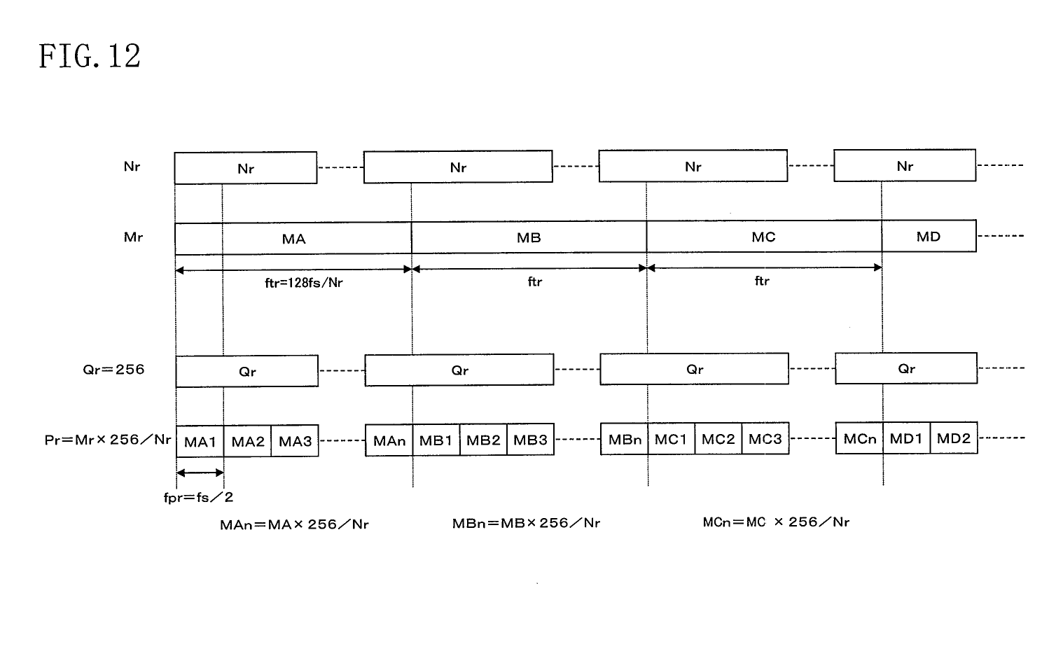

FIG. 12 is an exemplary diagram showing the concept of regeneration of a frequency division parameter. As shown in FIG. 12, the original frequency division parameter Mr varies like MA→MB→MC at the frequency ftr (=128 fs/Nr, e.g., about 1 kHz), while the regenerated frequency division parameter Pr varies like MA1→MA2→ . . . →MB1→MB2→ . . . →MC1→MC2→ . . . at the frequency fpr (=fs/2). In other words, by the regeneration of a frequency division parameter, the varying frequency ftr within the audio data band is converted into the varying frequency fpr that is higher than the audio data band.

It is here assumed that the frequency division parameter regenerating unit 28 is configured to output an integer value as Pr, where an average value of the outputs is equal to the value of Pr that is obtained by calculation.

In this case, when the original frequency division parameter Mr, Nr has a combination of values that causes Pr (=256×Mr/Nr) to have an integer value (e.g., 100, etc.), Pr output from the frequency division parameter regenerating unit 28 has the same value (MA1=MA2=MAn) during a period when Mr has a constant value. In other words, in this case, as a result, the variation of Pr has the same period (frequency ftr) as the period of variation of the original Mr.

The same is true of when Pr has a value close to an integer (e.g., 100.0625, 99.984375, etc.), i.e., in this case, Pr has a period of variation close to the variation period of the original Mr. For example, when Pr=100.0625=100+1/16, the frequency division parameter regenerating unit 28 outputs “100” fifteen times and “101” once in sixteen times of Pr output. Thus, Pr is output so that the average value of the outputs is “(100×15+101×1)/16=100.0625”. In this case, when Mr has a constant value, substantially the same value “100” is output, so that the variation of Pr has a period close to that of the variation of the original Mr.

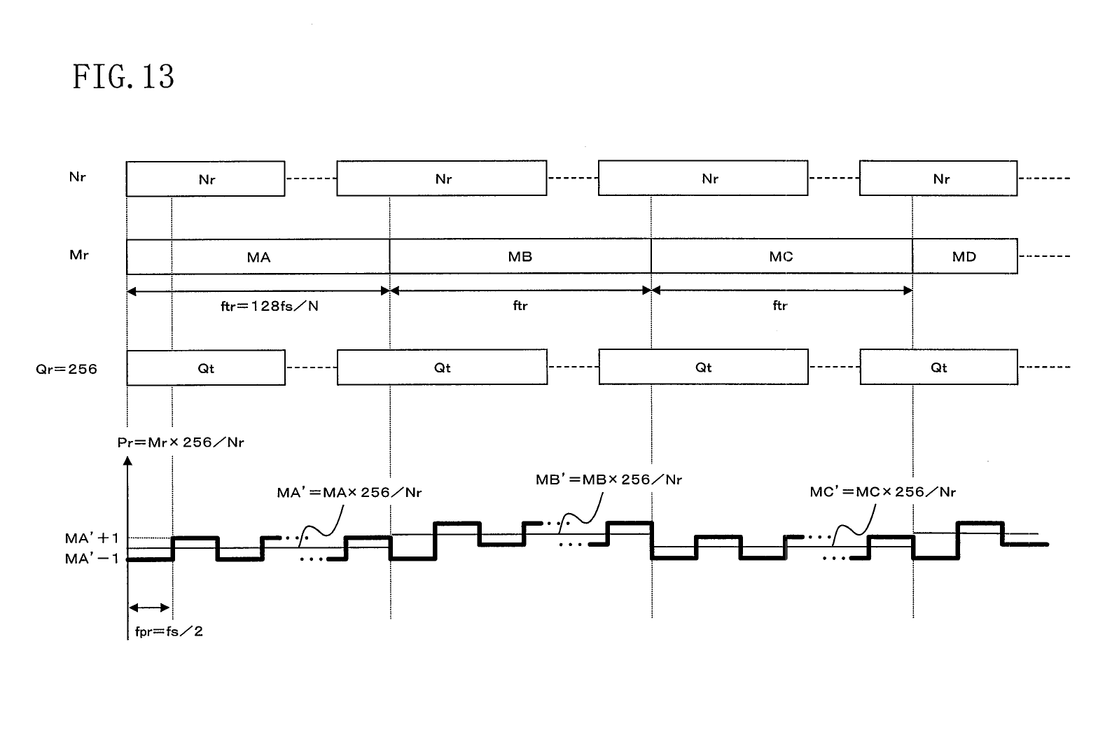

Thus, when the variation frequency fpr of Pr is eventually close to the variation frequency ftr of the original Mr, a higher-sound quality analog audio signal can be obtained. Therefore, an exemplary method for reliably converting the variation frequency fpr of Pr into a value that falls outside of the audio data band even when Pr has an integer value or a value close to an integer value, will be described with reference to FIG. 13.

Specifically, as shown in FIG. 13, it is assumed that when the calculated value of Pr is an integer value or a value close to an integer value, the frequency division parameter regenerating unit 28 alternately outputs the integer value ±1. For example, when the calculated value of Pr is MA′, the frequency division parameter regenerating unit 28 alternately outputs “MA′−1” and “MA′+1” as the value of Pr. In this case, the average output value of Pr is MA′, and the variation frequency of Pr is fpr=fs/2, which falls outside of the audio data band. Next, when Mr is updated to MB, similarly “MB′=MB×256/Nr” is calculated and “MB′−1” and “MB′+1” are alternately output.

The process described above can be considered as superimposition of a “noise sequence whose average value is zero” (e.g., represented by {−1, +1, −1, +1, . . . }) on the average output value of Pr. Note that the amplitude of noise is not necessarily limited to “±1”, and any amplitude may be employed.

Also, when the fractional part of Pr is close to 0.5 (e.g., Pr=76.5), a “noise sequence whose average value is zero” does not necessarily need to be superimposed. The output sequence of Pr may be a repetition of {76, 77} (e.g., {76, 77, 76, 77, . . . }) (this is only an example, and a repetition of {77, 76} is possible). Even if the output sequence of Pr includes consecutive sequences of “76” and “77” (e.g., {76, 76, . . . , 76, 77, 77, 77, . . . , 77}), the same average value, i.e., 76.5, is obtained. However, in order to obtain as high a variation frequency Pr as possible, it is preferable to output a sequence of output values having as many variations as possible. As the fractional part of Pr is closer to 0.5, a “sequence of output values having more variations” can be created. In other words, as the fractional part of Pr is farther away from 0.5 (closer to an integer value), it is more preferable to superimpose a “noise sequence whose average value is zero” so as to output a “sequence of output values having more variations”.

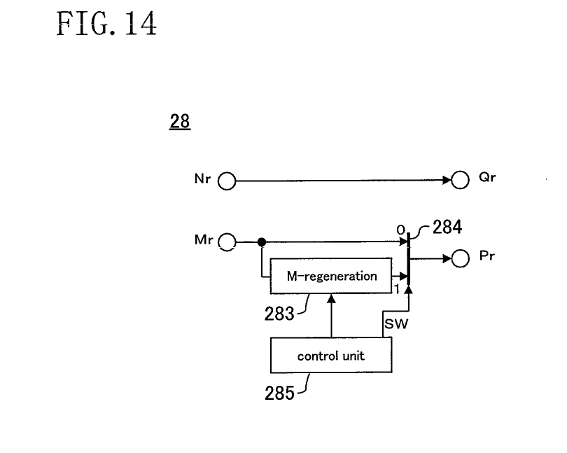

Next, a case where fpr is converted into a frequency that is lower than the lower limit of the audio data band will be described. It is here assumed that fpr=20 Hz. Note that if it is assumed that Qr=128×fs/20, Pr and Qr can be regenerated in a manner similar to that which has been described above. However, here, for the sake of simplicity, assuming that Qr=Nr, a case where conversion to substantially fpr=20 Hz is performed will be described. FIG. 14 is an exemplary diagram showing an internal configuration of the frequency division parameter regenerating unit 28 in this case.

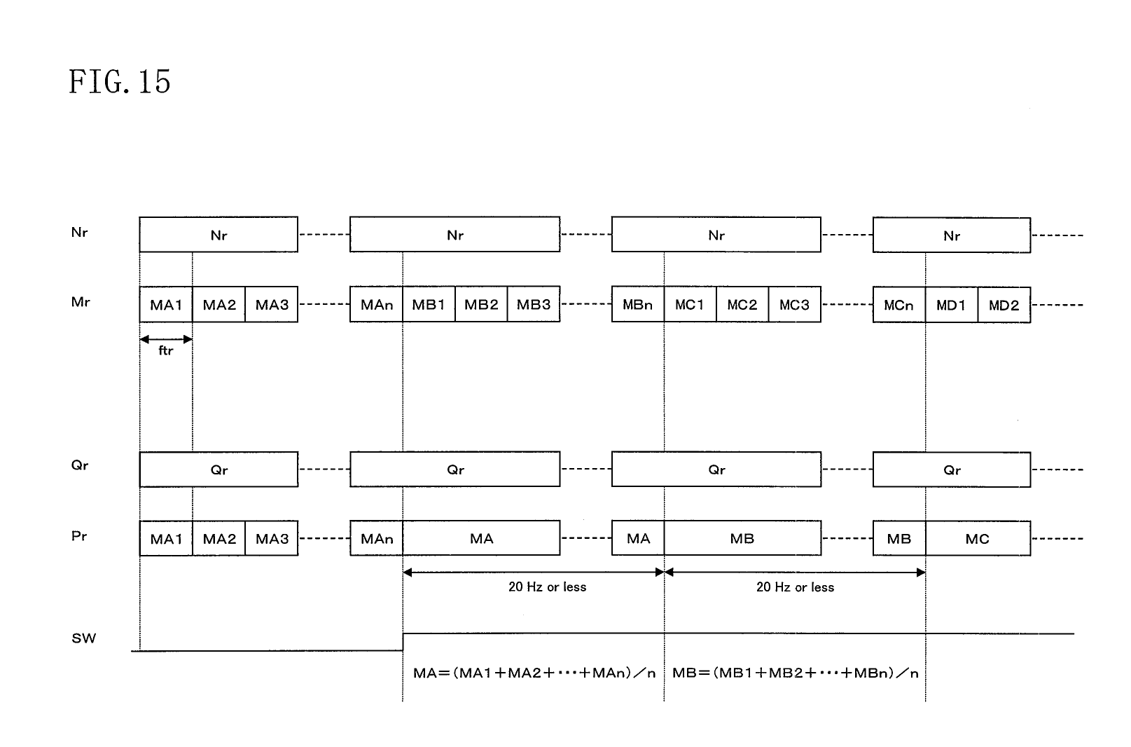

The frequency division parameter regenerating unit 28 outputs, as Qr, the same value as Nr. An M-regeneration unit 283 generates a new Pr using n Mr values that vary at the frequency ftr. FIG. 15 is an exemplary diagram showing the concept of such regeneration of a frequency division parameter.

As shown in FIG. 15, the M-regeneration unit 283 obtains one MA from MA1 to MAn. An average value, a median or the like of MA1 to MAn may be employed as MA. Similarly, the M-regeneration unit 283 obtains MB from MB1 to MBn, and MC from MC1 to MCn. Thus, MA, MB, MC, and so on are obtained as Pr.

If it is here assumed that ftr=1 kHz and n=50, Pr (MA, MB, MC, . . . ) has a variation period of 1 kHz/50=20 Hz. Thus, even if it is assumed that Qr=Nr, Pr having a variation period of substantially 20 Hz can be regenerated.

However, in this state, until MA is first output, Pr is not output, so that audio cannot be reproduced. To avoid this problem, a switch 284 and a control unit 285 are provided so that original Mr (i.e., MA1, MA2, MA3, . . . , MAn) is output as Pr until MA is output. With this configuration, reproduction of audio can be continuously performed from the beginning.

Also, in the case of the above-described method, for example, when the sampling frequency fs is switched partway through reproduction, the output of Pr cannot be quickly switched, so that an audio clock becomes extraordinary (i.e., the frequency of the audio clock suddenly varies to an abnormal degree, so it generates some noise, such crackling, clapping or popping sounds) for a moment (about 50 ms in the case of conversion to fpr=20 Hz).

To avoid this problem, a means for detecting large changes (i.e., a change whose absolute value exceeds a predetermined threshold value), for example, ±10, ±20, ±100 or ±200 in values of Nr and Mr is provided. When such a change is detected, the process of the M-regeneration unit 283 is stopped and is initialized, and thereafter, the Pr regeneration process is started over. Note that when the Pr regeneration process is started over, it takes a time to newly obtain Pr, and therefore, the control unit 285 outputs the original Mr directly as Pr for that time.

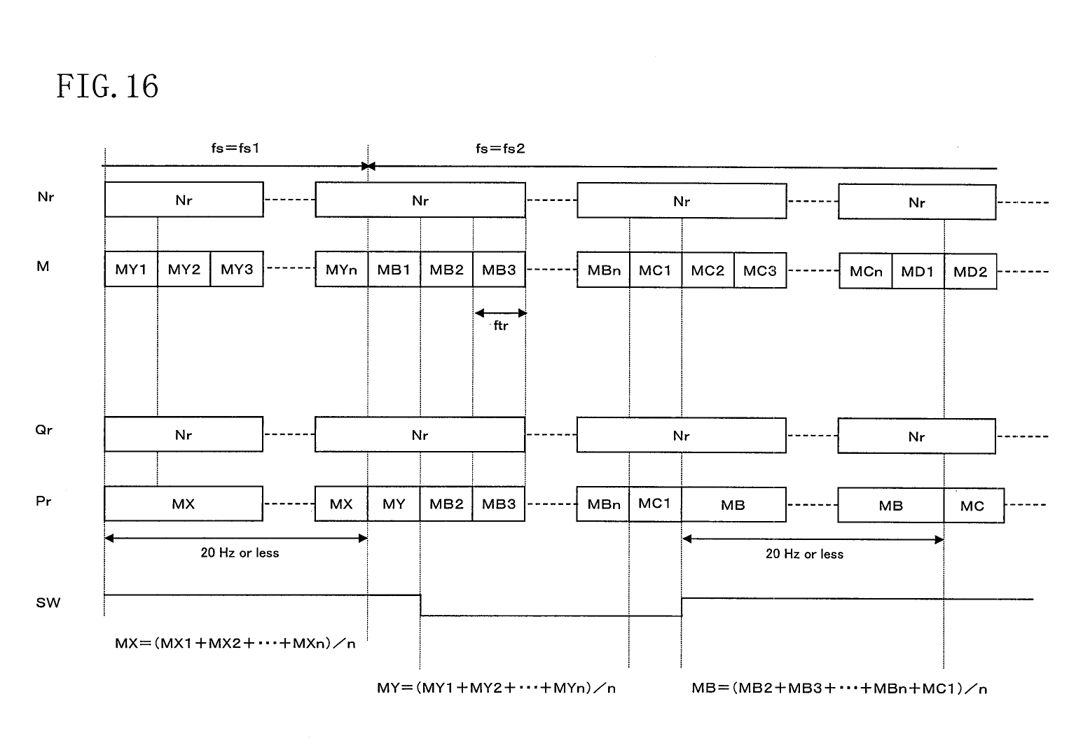

FIG. 16 is an exemplary diagram showing such a process. In FIG. 16, when the value of Mr is changed from MYn to MB1, the sampling frequency fs is switched from fs1 to fs2, i.e., a large change occurs in the value of Mr. When such a change is detected, the Pr regeneration process may be immediately stopped. However, in the example of FIG. 16, the Pr regeneration process is not immediately stopped. Instead, when MB2 is received, it is recognized that there is actually a large change in the value of Mr, and the Pr regeneration process is then stopped. Thus, it is recognized that there is actually a large change in the value of Mr only after two or more Mr values that have a large change are detected, thereby making it possible to reduce the probability that the Pr regeneration process is started over.

By such a process, even when the sampling frequency fs is switched partway through reproduction, the output of Pr can be caused to correctly follow the sampling frequency fs, so that it is possible to avoid the problem that an audio clock becomes extraordinary for a moment, so that audio output becomes extraordinary.

Thus, by providing the frequency division parameter regenerating unit 28 in the receiving apparatus 203 to regenerate a frequency division parameter, the variation frequency (the phase synchronization frequency of the PLL in the audio clock reproducing unit) fpr of the frequency division parameter can be converted into a frequency higher than the audio data band or a frequency lower than the audio data band. Therefore, even when a frequency division parameter similar to that of the conventional art is transmitted, high-sound quality audio data can be reproduced as in the first embodiment.

Although both the case where fpr is converted into a frequency higher than the audio data band and the case where fpr is converted into a frequency lower than the audio data band have been described above, high-sound quality audio data can be reproduced if either of the cases may be possible. Alternatively, a receiving apparatus may be configured to be able to perform both of the conversions, and the user may be able to select either of them using a menu screen, for example, or they may be automatically switched, depending on audio data. When they are automatically switched, they may be switched between, for example, music sources and movie sources.

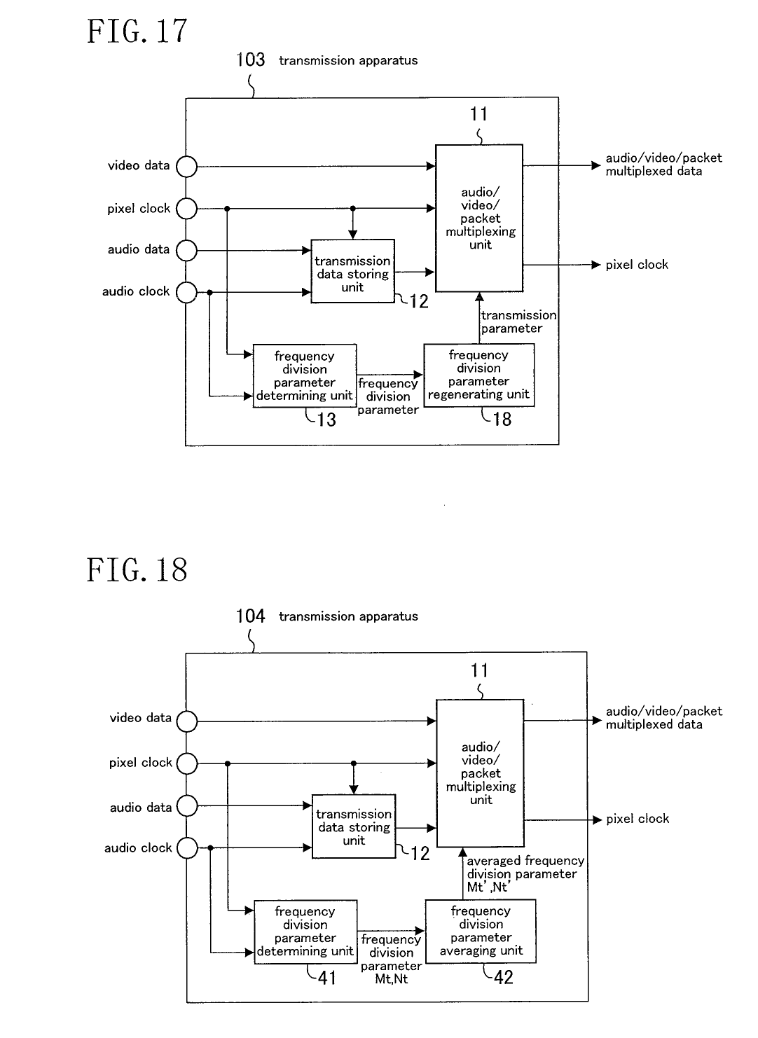

Also, as shown in FIG. 17, a frequency division parameter regenerating unit 18 similar to the frequency division parameter regenerating unit 28 may be added to a transmission apparatus 103. Thereby, by only adding the frequency division parameter regenerating unit 18 to the configuration of a conventional transmission apparatus, a transmission apparatus similar to that of the first embodiment can be easily achieved.

### Fourth Embodiment

In the first to third embodiments described above, the variation frequency of a frequency division parameter, i.e., the phase comparison frequency of the PLL of the audio clock reproducing unit in a receiving apparatus, is caused to fall out of the band of audio data, thereby reproducing a high-sound quality analog audio signal. In contrast to this, in a fourth embodiment of the present disclosure, by averaging a varying frequency division parameter, the variation of the frequency of an audio clock is suppressed, thereby reproducing a high-sound quality analog audio signal.

FIG. 18 is an exemplary block diagram showing an exemplary configuration of a transmission apparatus according to this embodiment. In FIG. 18, the same components as those of FIG. 1 are indicated by the same reference symbols and will not be described in detail again. The transmission apparatus 104 of FIG. 16 comprises an audio/video/packet multiplexing unit 11, a transmission data storing unit 12, a frequency division parameter determining unit 41, and a frequency division parameter averaging unit 42.

The frequency division parameter determining unit 41 determines and outputs a frequency division parameter Mt, Nt as in conventional transmission apparatuses The frequency division parameter averaging unit 42 averages the frequency division parameter Mt, Nt output from the frequency division parameter determining unit 41, and outputs an averaged frequency division parameter M′t, N′t. Note that only one of the frequency division parameters Mt and Nt may be averaged.

Various periods are considered for which the frequency division parameter averaging unit 42 performs averaging. For example, averaging may continue to be performed during a period for which the frequencies of a pixel clock and an audio clock do not vary, and when a change in the frequency of a pixel clock or an audio clock is detected, the previous average value may be abandoned, and an average value may be calculated after the frequency change. Alternatively, averaging may be performed every predetermined period, for example, 0.2 second (5 Hz), 1 second (1 Hz) or several seconds.

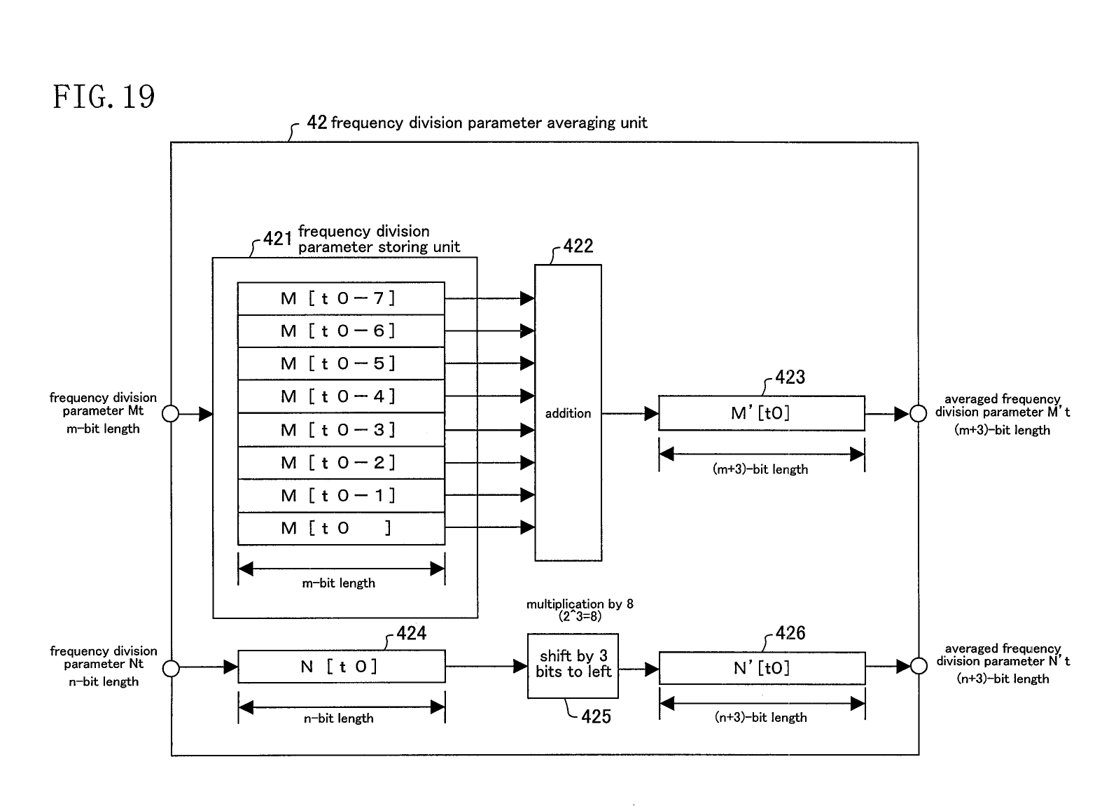

In this embodiment, it is assumed that n most recent values (n is an integer of 2 or more) are averaged. FIG. 19 is an exemplary diagram showing an exemplary internal configuration of the frequency division parameter averaging unit 42. It is assumed in FIG. 19 that Nt is a constant value, and eight most recent (=2̂3) Mt values are averaged. The averaged frequency division parameter M′t, N′t has a higher resolution of numerical representation than that of the original integer values Mt and Nt. In the configuration of FIG. 19, it is assumed that M′t has a length of (m+3) bits for Mt having a length of m bits, and N′t has a length of (n+3) bits for Nt having a length of n bits.

In FIG. 19, a frequency division parameter storing unit 421 stores eight most recent frequency division parameter values M[t0] to M[t0-7]. An adder 422 adds the eight frequency division parameter values M[t0] to M[t0-7] stored in the frequency division parameter storing unit 421 and stores the result into a (m+3)-bit length register 423. If the m most significant bits are considered as a whole number part and the three least significant bits are considered as a fractional part, the sum of the frequency division parameter values M[t0] to M[t0-7] is divided by 8 (=2̂3), there by obtaining an average value M′[t0]. Also, the frequency division parameter value N[t0] stored in an n-bit length register 424 is shifted to the left by three bits by a shifter 425 (i.e., multiplied by 8 (=2̂3)), and the result is stored into the (m+3)-bit length register 423. By considering the m most significant bits as a whole number part and the three least significant bits as a fractional part, an average value N′[t0] is obtained.

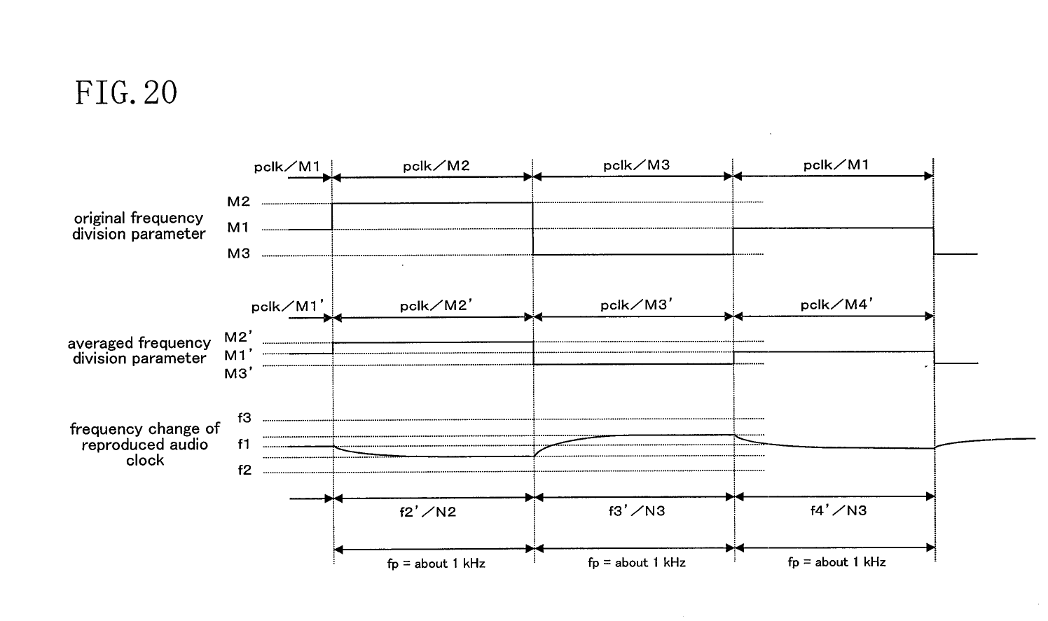

Thus, by averaging the frequency division parameter, the frequency variation of a reproduced audio clock is reduced as shown in FIG. 20. Specifically, even if an original frequency division parameter varies like M1, M2, M3, an averaged frequency division parameter M1′, M2′, M3′ has suppressed variations. Therefore, a reproduced audio clock also has suppressed frequency variations, so that distortion of an analog audio signal is also suppressed, thereby making it possible to achieve high-sound quality reproduction.

Note that when the averaged frequency division parameter is transmitted from the transmission apparatus to the receiving apparatus, a difference in frequency occurs between an audio clock in the transmission apparatus and an audio clock reproduced in the receiving apparatus because in the receiving apparatus the audio clock is reproduced based on the averaged frequency division parameter. Therefore, audio data transmission in the transmission apparatus and audio data reproduction in the receiving apparatus mismatch in terms of their rates as viewed in a small time interval. Therefore, overflow or underflow may occur in an audio data buffer memory in the receiving apparatus, resulting in a deterioration in audio quality, such as sound interruption, abnormal sound or the like.

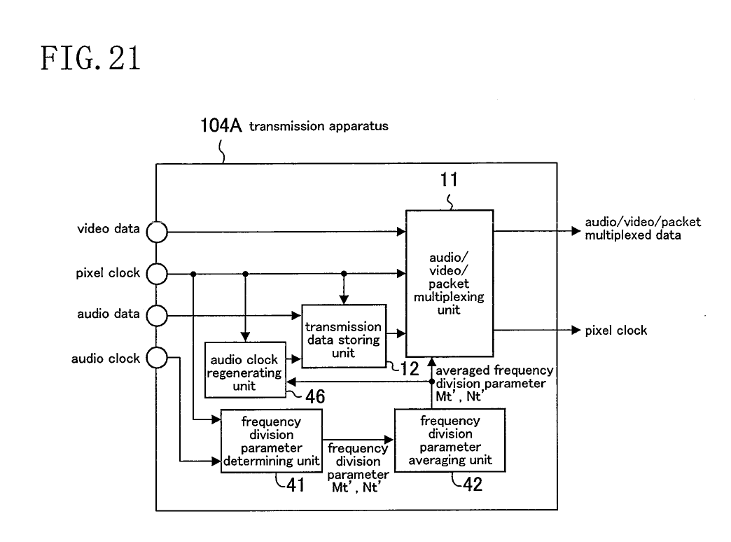

Therefore, as shown in FIG. 21, an audio clock regenerating unit 46 for generating a new audio clock based on an averaged frequency division parameter and a pixel clock is preferably provided. In a transmission apparatus 104A of FIG. 21, a transmission data storing unit 12 stores, as transmission data, audio data synchronized with the new audio clock generated by the audio clock regenerating unit 46. Thereby, audio data generation in the transmission apparatus and audio data reproduction in the receiving apparatus match in terms of their rates, so that a deterioration in audio quality can be prevented.

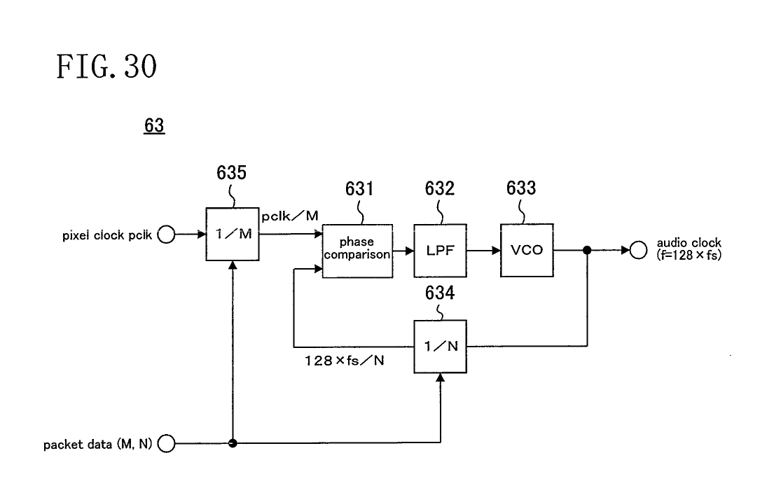

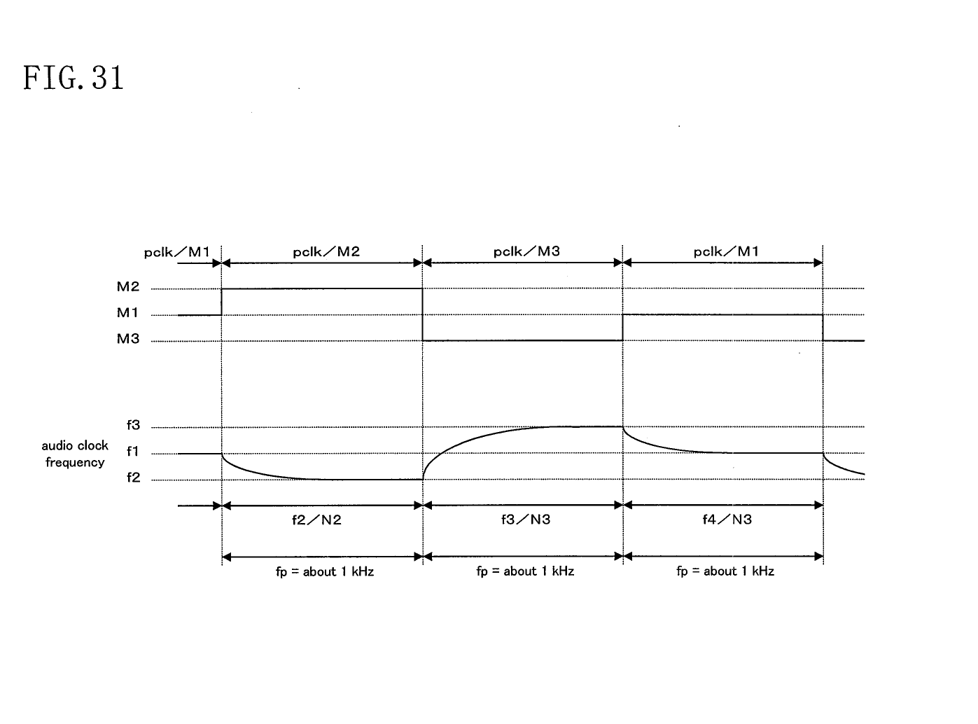

Note that the transmission data storing unit 12 may temporarily store audio data synchronous with an audio clock inputted from outside and the audio data may be transmitted at the timing synchronous with the new audio clock generated by the audio clock regenerating unit 46. That is, the audio data to be written into or to be read out of the transmission data storing unit 12 may be synchronized with the new audio clock generated by the audio clock regenerating unit 46. Note that in each case the audio clock regenerating unit 46 can be implemented by a configuration as shown, for example, in FIG. 30.

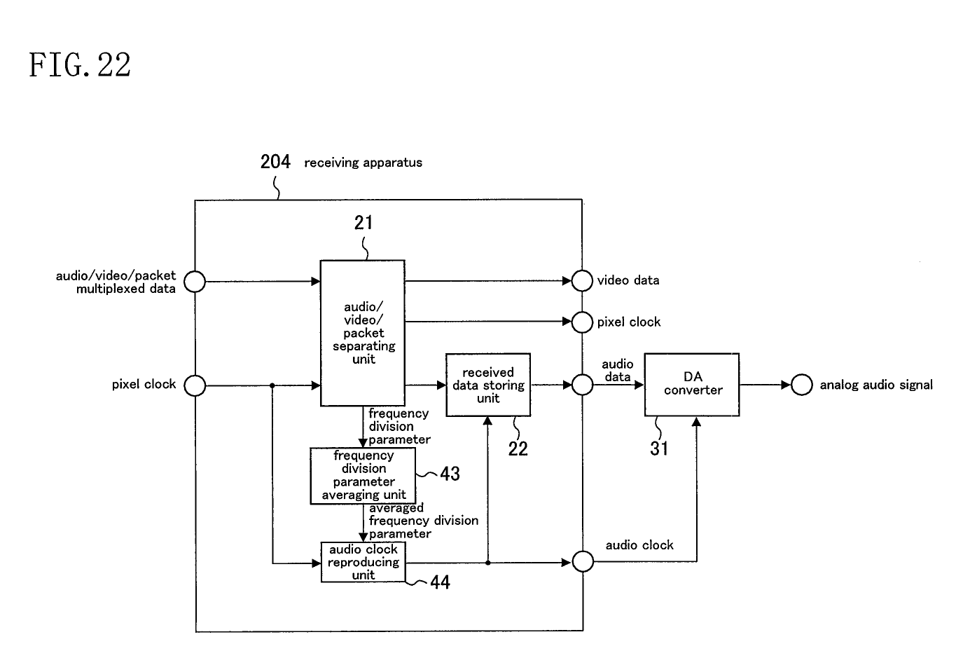

Also, a received frequency division parameter may be averaged in a receiving apparatus. FIG. 22 is an exemplary block diagram showing an exemplary configuration of a receiving apparatus according to this embodiment. In FIG. 22, the same components as those of FIG. 2 are indicated by the same reference symbols and will not be described in detail again. The receiving apparatus 204 of FIG. 22 comprises an audio/video/packet separating unit 21, a received data storing unit 22, a frequency division parameter averaging unit 43, and an audio clock reproducing unit 44.

The frequency division parameter averaging unit 43 averages a frequency division parameter Mt, Nt separated by the audio/video/packet separating unit 21, and outputs the resultant averaged frequency division parameter M′t, N′t. The configuration and operation of the frequency division parameter averaging unit 43 are similar to those of the frequency division parameter averaging unit 42 described above, and may be configured as shown in FIG. 19, for example.

The audio clock reproducing unit 44 may have a configuration basically similar to that of the conventional art. When the averaged frequency division parameter M′t, N′t has a higher resolution of numerical representation than that of the original integer values Mt and Nt, the configuration of the audio clock reproducing unit 44 needs to be modified. Note that this modification is also required when a frequency division parameter is averaged in a transmission apparatus.

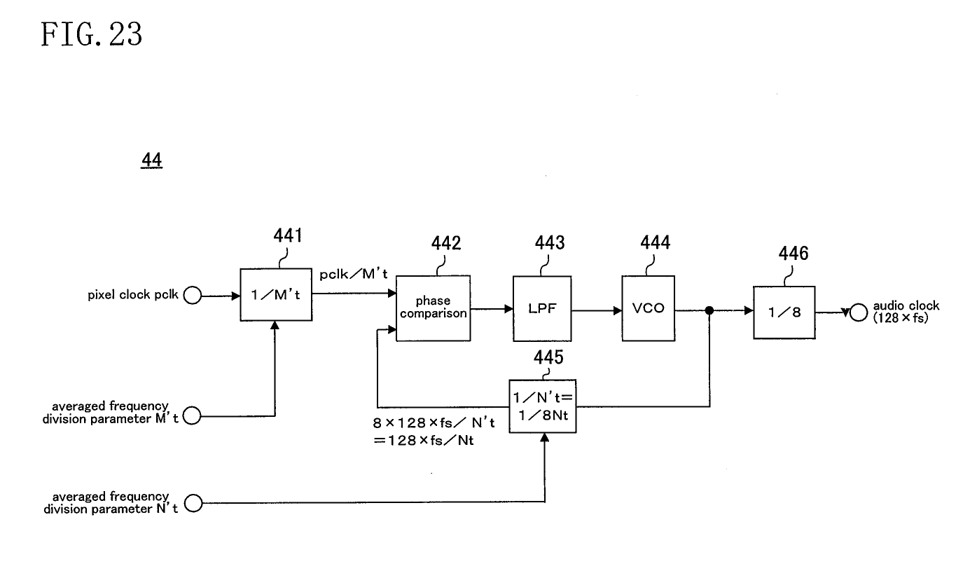

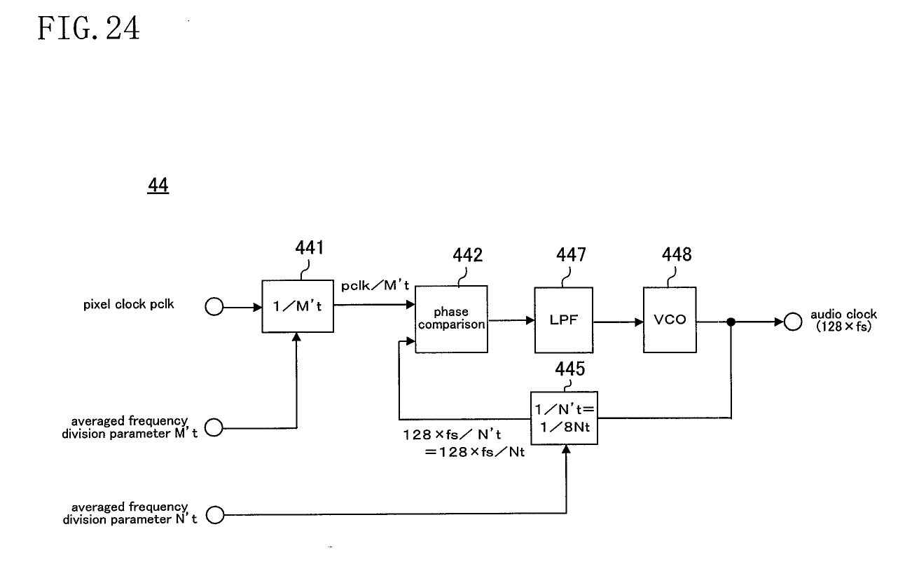

FIGS. 23 and 24 show an exemplary internal configuration of the audio clock reproducing unit 44. In the configuration of FIGS. 23 and 24, the accuracy of the averaged frequency division parameter M′t is assumed to be increased by a factor of eight. In the configuration of FIG. 23, since the accuracy of M′t is increased by a factor of eight, the accuracy of oscillation frequency of a VCO 444 is increased by a factor of eight so as to increase the accuracy of comparison by a factor of eight. In addition, at a stage subsequent to the VCO 44, a frequency divider 446 for obtaining the ⅛ frequency of a clock output from the VCO 444 to generate an audio clock is provided. A frequency divider 441 for frequency-dividing a pixel clock, a phase comparator 442, a low-pass filter 443, and a frequency divider 445 for frequency-dividing a VCO output are similar to those of the conventional art. In this configuration, the phase comparison period is the same as that of the conventional art.

The configuration of FIG. 24 has an accuracy of M′t that is increased by a factor of eight, i.e., a phase comparison frequency that is decreased by a factor of eight. Note that, in this case, the characteristics of a low-pass filter 447 are preferably changed so that, for example, the cutoff frequency is ⅛ times as high as that of the conventional art. A frequency divider 441 for frequency-dividing a pixel clock, a phase comparator 442, a VCO 448, and a frequency divider 445 for frequency-dividing a VCO output are similar to those of the conventional art.

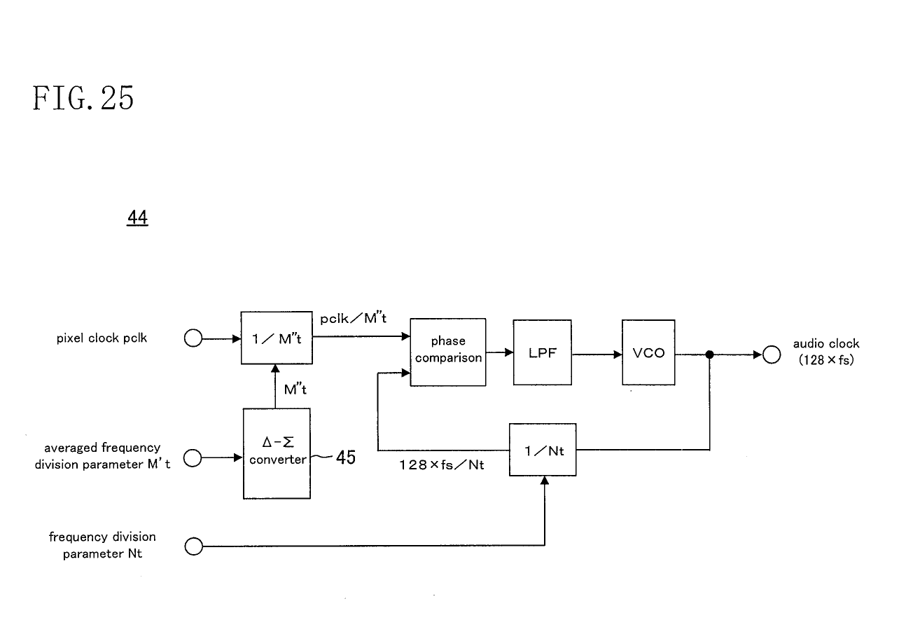

FIG. 25 is an exemplary diagram showing another exemplary configuration of the audio clock reproducing unit 44. In the configuration of FIG. 25, a Δ−Σ converter 45 is provided so that the averaged frequency division parameter M′t is converted into an original resolution (integer value) before being used for reproduction of an audio clock. The components other than the Δ−Σ converter 45 are similar to those of the conventional art.

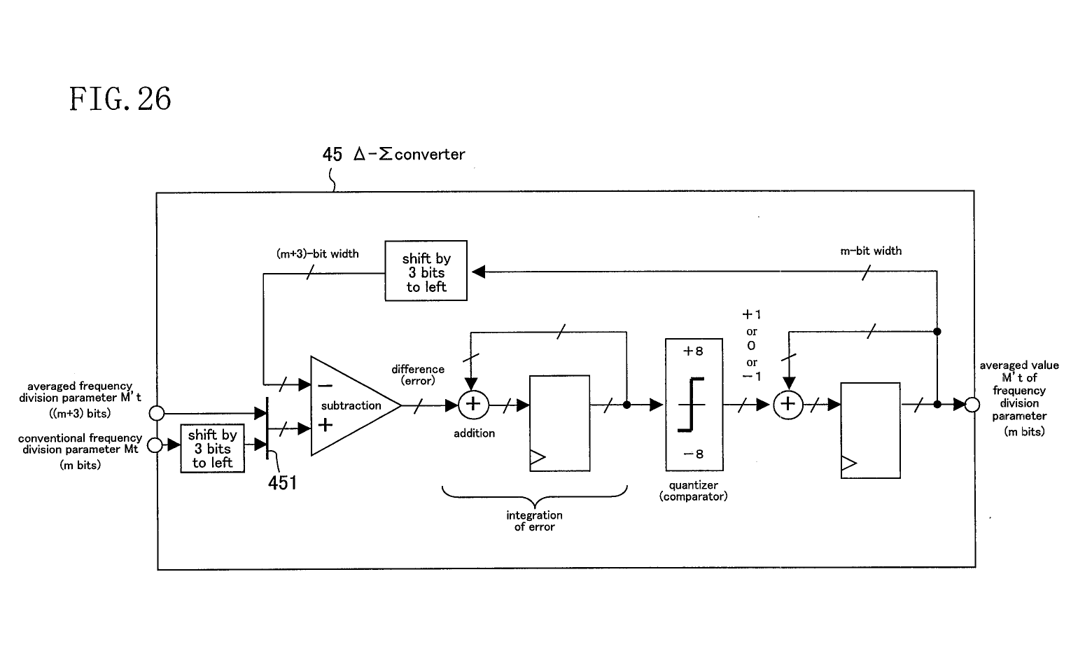

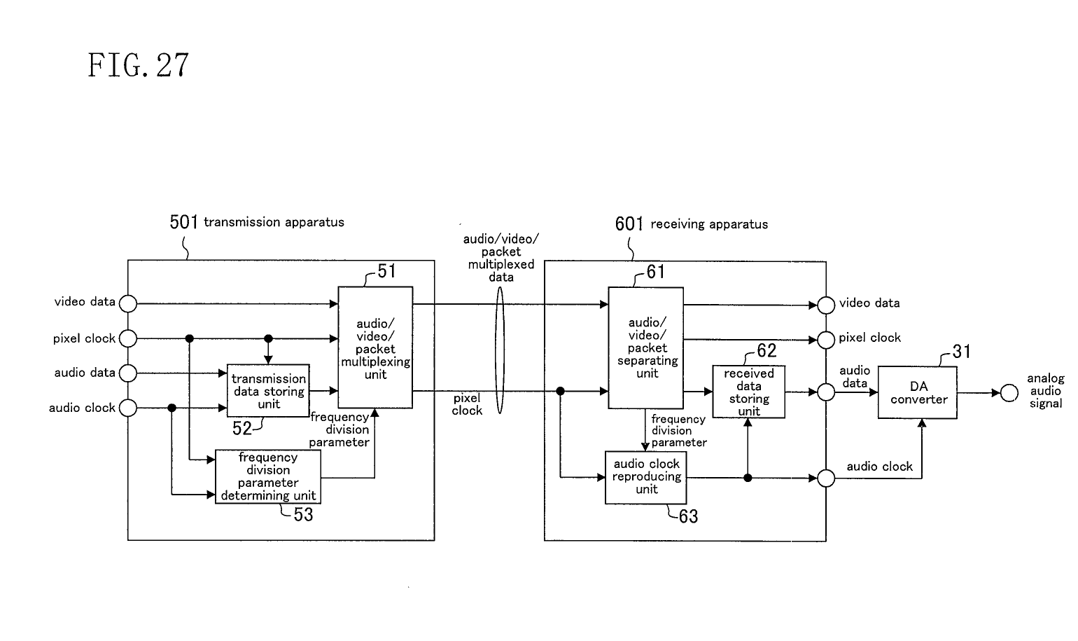

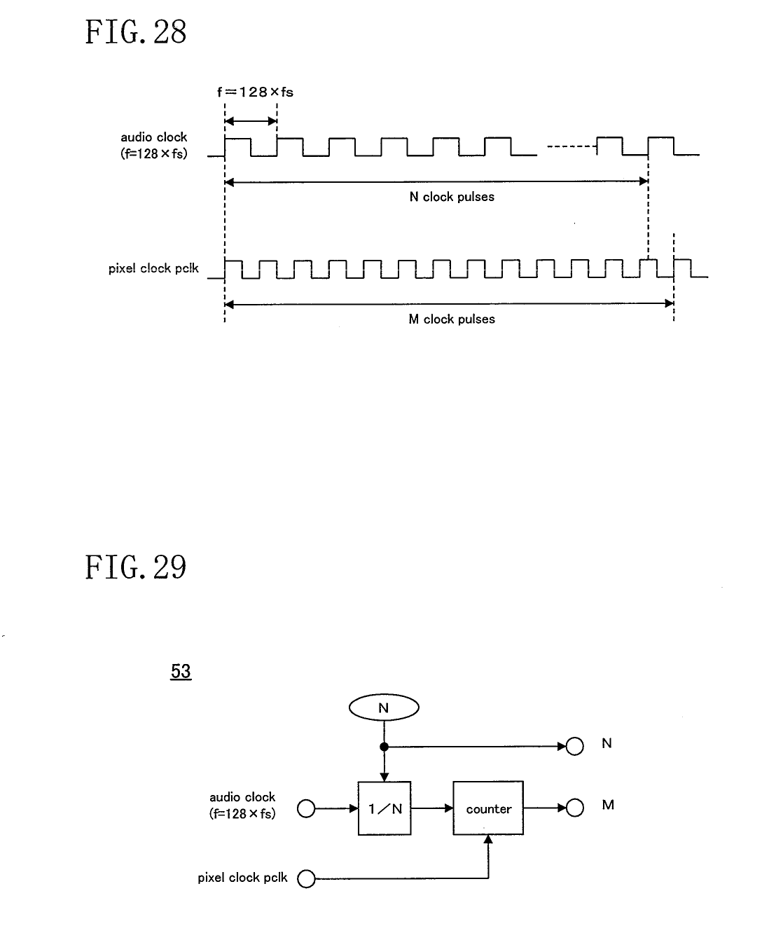

FIG. 26 is an exemplary diagram showing an exemplary configuration of the Δ−Σ converter 45. In the configuration of FIG. 26, the averaged frequency division parameter M′t of (m+3) bits is input and converted into an average value M″t of m bits. To achieve this conversion, a difference (error) between an input and an output is integrated, the resultant integration value is quantized, and the quantized value is added to or subtracted from the output. Also, the conventional m-bit frequency division parameter Mt can also be input. For example, a selector 451 may be switched, depending on the header of a packet. The output M″t corresponds to the result of rounding M′t or to an average value of Mt.

In the configuration of FIGS. 25 and 26 in which a Δ−Σ converter is employed, it is not necessary to increase the oscillation frequency of the VCO, so that power consumption is reduced and a clock frequency dividing circuit subsequent to the VCO is not required, as compared to the configuration of FIG. 23. Also, as compared to the configuration of FIG. 24, since it is not necessary to change the filter characteristics of the low-pass filter, both the conventional frequency division parameter and the averaged frequency division parameter can be supported, and therefore, it is not necessary to provide two low-pass filters having different characteristics and switch these filters. Moreover, the conventional frequency division parameter can be averaged, so that higher-sound quality can be easily obtained.

As described above, according to this embodiment, a varying frequency division parameter is averaged, so that the variation of the frequency of an audio clock can be suppressed, thereby making it possible to reproduce a high-sound quality analog audio signal.

Note that the components of the various embodiments above may be used in any combination within the scope and spirit of the present disclosure.

As described above, according to the present disclosure, high-sound quality audio data can be transmitted via a digital interface, such as the HDMI or the like, and therefore, is effective to, for example, an improvement in quality of audio data when digital home appliances are connected to a network.

What is claimed is:

1. A transmission apparatus in a digital interface for audio/video transmission, comprising:
a frequency division parameter control unit for outputting a frequency division parameter relating a pixel clock for video data with an audio clock for audio data; and
a multiplexing unit for converting audio data and the frequency division parameter output from the frequency division parameter control unit into packets, and superimposing the packets into blanking intervals of video data so as to produce transmission data,
wherein the transmission apparatus transmits the transmission data and the pixel clock, and
the frequency division parameter control unit outputs two integer values Pt and Qt as the frequency division parameter that satisfy a relationship represented by:
pclk/Pt=ft/Qt=fpt
where pclk represents a frequency of the pixel clock, and fit represents a frequency of the audio clock, and that cause fpt to fall outside of a predetermined band.

2. The transmission apparatus of claim 1, wherein
the predetermined band is a frequency range of 300 Hz to 3 kHz.

3. The transmission apparatus of claim 1, wherein
the predetermined band is a human audio-frequency range of 20 Hz to 20 kHz.

4. The transmission apparatus of claim 1, wherein
the predetermined band is a human voice-frequency range of 300 Hz to 4 kHz.

5. The transmission apparatus of claim 1, wherein
the predetermined band is determined based on a minimum frequency and a maximum frequency included in the audio data.

6. The transmission apparatus of claim 1, wherein
the frequency division parameter control unit sets fpt to be V/U (U and V are integers) of a sampling frequency fs of the audio data.

7. The transmission apparatus of claim 1, wherein
the integer value Qt is a fixed value, and only the integer value Pt is output as the frequency division parameter.

8. The transmission apparatus of claim 1, wherein
the frequency division parameter control unit is configured to be able to output at least one type of frequency division parameter in addition to the frequency division parameter Pt, Qt.

9. A transmission apparatus in a digital interface for audio/video transmission, comprising:
a frequency division parameter determining unit for determining, as a frequency division parameter for relating a pixel clock for video data with an audio clock for audio data, two integer values Mt and Nt that satisfy a relationship represented by:
pclk/Mt=ft/Nt
where pclk represents a frequency of the pixel clock and ft represents a frequency of the audio clock;
a frequency division parameter averaging unit for averaging at least one of Mt and Nt, and outputting the result as an averaged frequency division parameter; and
a multiplexing unit for converting audio data and the averaged frequency division parameter into packets, and superimposing the packets into blanking intervals of video data so as to produce transmission data,
wherein the transmission apparatus transmits the transmission data and the pixel clock.

10. The transmission apparatus of claim 9, wherein
a resolution of numerical representation of the averaged frequency division parameter is higher than a resolution of numerical representation of Mt and Nt.

11. The transmission apparatus of claim 9, wherein
the frequency division parameter averaging unit, when detecting a change in frequency of the pixel clock or the audio clock, disregards a previous average value and begins averaging after the frequency change.

12. The transmission apparatus of claim 9, further comprising:
an audio clock regenerating unit for generating a new audio clock based on the averaged frequency division parameter and the pixel clock,
wherein audio data synchronous with the new audio clock is used as the audio data.

13. The transmission apparatus of claim 1, wherein
the digital interface is the High-Definition Multimedia Interface (HDMI).

14. A receiving apparatus in a digital interface for audio/video transmission, comprising:
a separating unit for separating, from received data, video data, audio data, and a frequency division parameter for relating a pixel clock for the video data with an audio clock for the audio data;
an audio clock reproducing unit having a Phase Locked Loop (PLL), for reproducing an audio clock from a received pixel clock and the frequency division parameter by the PLL operating in a manner that satisfies a relationship represented by:
pclk/Pr=fr/Qr=fpr
where pclk represents a frequency of the pixel clock, fr represents a frequency of the reproduced audio clock, and Pr and Qr represent the frequency division parameter; and
a band determining unit for determining a band of fpr in the audio clock reproducing unit,
wherein the audio clock reproducing unit switches loop characteristics of the PLL, depending on a result of determination by the band determining unit.

15. The receiving apparatus of claim 14, wherein
the band determining unit determines the band of fpr by comparing the frequency division parameter with a predetermined value.

16. The receiving apparatus of claim 14, wherein
the band determining unit determines the band of fpr based on a value of a header of a packet including the frequency division parameter.

17. A receiving apparatus in a digital interface for audio/video transmission, comprising:
a separating unit for separating, from received data, video data, audio data, and a frequency division parameter for relating a pixel clock for the video data with an audio clock for the audio data; and
an audio clock reproducing unit having a Phase Locked Loop (PLL), for reproducing an audio clock from a received pixel clock and the frequency division parameter by an operation of the PLL,
wherein the audio clock reproducing unit supports at least two types of frequency division parameters, and switches loop characteristics of the PLL, depending on the frequency division parameter type.

18. A receiving apparatus in a digital interface for audio/video transmission, comprising:
a separating unit for separating, from received data, video data, audio data, and a frequency division parameter for relating a pixel clock for the video data with an audio clock for the audio data;
a frequency division parameter regenerating unit for regenerating a new frequency division parameter from the frequency division parameter; and
an audio clock reproducing unit having a Phase Locked Loop (PLL), for reproducing an audio clock from a received pixel clock and the new frequency division parameter by an operation of the PLL,
wherein the frequency division parameter regenerating unit regenerates, as the new frequency division parameter, two integer values Pr and Qr that satisfy a relationship represented by:
pclk/Pr=ft/Qr=fpr
where pclk represents a frequency of the pixel clock and ft represents a frequency of the audio clock, and that cause fpr to fall outside of a predetermined band.

19. The receiving apparatus of claim 18, wherein
the predetermined band is a frequency range of 300 Hz to 3 kHz.

20. The receiving apparatus of claim 18, wherein
the predetermined band is a human audio-frequency range of 20 Hz to 20 kHz.

21. The receiving apparatus of claim 18, wherein
the predetermined band is a human voice-frequency range of 300 Hz to 4 kHz.

22. The receiving apparatus of claim 18, wherein
the predetermined band is determined based on a minimum frequency and a maximum frequency included in the audio data.

23. The receiving apparatus of claim 18, wherein
the frequency division parameter regenerating unit sets fpr to be V/U (U and V are integers) of a sampling frequency fs of the audio data.

24. A receiving apparatus in a digital interface for audio/video transmission, comprising:
a separating unit for separating, from received data, video data, audio data, and a frequency division parameter for relating a pixel clock for the video data with an audio clock for the audio data;
a frequency division parameter averaging unit for averaging the frequency division parameter and outputs the averaged frequency division parameter; and
an audio clock reproducing unit having a Phase Locked Loop (PLL), for reproducing an audio clock from a received pixel clock and the averaged frequency division parameter.

25. The receiving apparatus of claim 24, wherein
the frequency division parameter averaging unit, when detecting a change in frequency of the pixel clock or the audio clock, abandons a previous average value and starts over averaging after the frequency change.

26. The receiving apparatus of claim 14, wherein
the digital interface is the High-Definition Multimedia Interface (HDMI).

27. The transmission apparatus of claim 9, wherein
the digital interface is the High-Definition Multimedia Interface (HDMI).

28. The receiving apparatus of claim 17, wherein
the digital interface is the High-Definition Multimedia Interface (HDMI).

29. The receiving apparatus of claim 18, wherein
the digital interface is the High-Definition Multimedia Interface (HDMI).

30. The receiving apparatus of claim 24, wherein
the digital interface is the High-Definition Multimedia Interface (HDMI).
